(19) United States
(12) Patent Application Publication
(10) Pub. No.: US 2010/0020273 A1
(43) Pub. Date: Jan. 28, 2010

(54) POLYMER FILM, POLARIZING PLATE, AND LIQUID CRYSTAL DISPLAY

(75) Inventors: Hirofumi Toyama, Minami-ashigara-shi (JP); Kotaro Yasuda, Minami-ashigara-shi (JP); Yusuke Ino, Minami-ashigara-shi (JP); Yujiro Yanai, Minami-ashigara-shi (JP); Yasuyuki Sasada, Minami-ashigara-shi (JP); Jun Takeda, Minami-ashigara-shi (JP)

Correspondence Address: BUCHANAN, INGERSOLL & ROONEY PC, POST OFFICE BOX 1404, ALEXANDRIA, VA, 22313-1404, US

(73) Assignee: FUJIFILM Corporation, Minato-ku (JP)

(21) Appl. No.: 12/507,944

(22) Filed: Jul. 23, 2009

(30) Foreign Application Priority Data
Jul. 24, 2008 (JP) 2008-190713

(51) Int. Cl. G02F 1/1335; G02B 1/08

(52) U.S. Cl. 349/96; 359/500

(57) ABSTRACT

A polymer film stretched after formed by solution casting, of which the wavelength dispersion of the refractivity anisotropy and/or the refractivity anisotropy differ between two surfaces of the film is disclosed.

### CROSS-REFERENCE TO RELATED APPLICATIONS

This application claims benefit of priority under 35 U.S.C. 119 to Japanese Patent Application No. 2008-190713 filed on Jul. 24, 2008, which is expressly incorporated herein by reference in its entirety.

### BACKGROUND OF THE INVENTION

1. Technical Field

The present invention relates to a polymer film useful as a component part of liquid-crystal display devices and the like, and to a polarizing plate and a liquid-crystal display device comprising the film.

2. Background Art

Applications of liquid-crystal display devices are expanding year by year as power-saving and space-saving image display devices. Heretofore, one serious defect of liquid-crystal display devices is that the viewing angle dependence of image display is large. However, VA-mode or IPS-mode, wide viewing angle liquid-crystal display devices have been put into practical use, and in that situation, the demand for liquid-crystal display devices is rapidly expanding even in the market of TVs and others that require high-definition image expression.

Various optical compensation mechanisms have been proposed for those modes of liquid-crystal display devices.

For example, WO2004/068226 discloses a biaxial compensatory film of which the in-plane retardation Re exhibits reversed wavelength dispersion characteristics and the thickness-direction retardation Rth exhibits regular wavelength dispersion characteristics, saying that the compensatory film is effective for solving the problem of color shift in VA-mode displays. However, it is difficult to realize the contradictory properties of regular wavelength dispersion characteristics of retardation and reversed wavelength dispersion characteristics thereof in one film.

JP-A No. 2006-323152 proposes a transparent film of which the ratio of Re to Rth, Re/Rth varies in the direction of the thickness of the film, as an optically-compensatory film of liquid-crystal display devices, especially VA-mode liquid-crystal display devices; however, this does not illustrate a technology of changing the refractivity anisotropy (Δn=nx−ny) between the two surfaces of the film, and does not describe at all the wavelength dispersion characteristics of the refractivity anisotropy of the film.

On the other hand, a retardation film is disclosed, which comprises a material having refractivity anisotropy in the film thickness direction and in which the material has a concentration gradient in the film thickness direction (JP-A No. 2006-221134). However, in JP-A No. 2006-221134, the material having refractivity anisotropy is controlled to have a concentration gradient for the purpose of enhancing the adhesiveness between the retardation film and the polarizing film to be adjacent thereto; but this reference describes nothing relating to the optical characteristics of the retardation film that may result from the concentration gradient.

### SUMMARY OF THE INVENTION

An object of the present invention is to provide a novel polymer film useful as an optically-compensatory film, and to provide a polarizing plate and a liquid-crystal display device comprising the film.

Another object of the invention is to provide the novel polymer film as well as a polarizing plate and a liquid-crystal display device comprising the film, in which the difference in the wavelength dispersion characteristics of refractivity anisotropy between the two surfaces of the film and/or the difference in the refractivity anisotropy between the two surfaces of the film is utilized for optical compensation, as well as Re and Rth.

Still another object of the invention is to provide the novel polymer film useful as an optically-compensatory film, which is suitable to continuous production.

The means for achieving the objects are as follows.
[1] A polymer film stretched after prepared according to solvent casting method, of which the wavelength dispersion of the refractivity anisotropy and/or the refractivity anisotropy differs between two surfaces of the film.
[2] The polymer film of [1], having a gradation in the wavelength dispersion characteristics of the refractivity anisotropy and/or in the refractivity anisotropy along the thickness direction of the film.
[3] The polymer film of [1] or [2], of which the in-plane retardation (Re) is larger at a longer wavelength within a wavelength range of from 430 nm to 700 nm.
[4] The polymer film of any one of [1]-[3], of which the refractivity anisotropy in one of the two surfaces of the film is larger than the refractivity anisotropy at the center point in the thickness direction of the film.
[5] The polymer film of any one of [1]-[4], comprising at least one material having reversed wavelength dispersion characteristics.
[6] The polymer film of any one of [1]-[5], comprising at least one material having reversed wavelength dispersion characteristics and at least one material having regular wavelength dispersion characteristics.
[7] The polymer film of any one of [1]-[6], comprising at least one cellulose acylate as the main ingredient thereof.
[8] The polymer film of any one of [1]-[7], comprising a cellulose acylate having at least two different types of substituents.
[9] A polarizing plate comprising a polarizing film and a polymer film of any one of [1]-[8] disposed on at least one surface of the polarizing film.
[10] The polarizing film of [9], wherein the polymer film is a polymer film of which the wavelength dispersion of the refractivity anisotropy differs between two surfaces of the film, and wherein the surface of the film having a larger level of reversed wavelength dispersion characteristics is disposed to face the side of the polarizing film.
[11] A liquid-crystal display comprising at least one polarizing plate of [9] or [10].
[12] The liquid-crystal display of [11], employing a vertically aligned mode.
[13] The liquid-crystal display of [11], employing a horizontally aligned mode.

According to the invention, it is possible to provide a novel polymer film useful as an optically-compensatory film, and to provide a polarizing plate and a liquid-crystal display device comprising the film.

According to the invention, it is also possible to provide the novel polymer film as well as a polarizing plate and a liquid-crystal display device comprising the film, in which the difference in the wavelength dispersion characteristics of refractivity anisotropy between the two surfaces of the film and/or the difference in the refractivity anisotropy between the two surfaces of the film is utilized for optical compensation, as well as Re and Rth.

According to the invention, it is possible to provide the novel polymer film useful as an optically-compensatory film, which is suitable to continuous production.

### BRIEF DESCRIPTION OF THE DRAWINGS

FIG. 1 (1)-(3) show schematic views of examples of a polymer film of the invention combined with a polarizing element and an example of an ordinary polymer film combined with a polarizing element, to which a linearly-polarized light is applied on the side of the polarizing element.

FIG. 2 (1)-(3) show schematic views of the trace of the polarization state change of the linearly-polarized light running through the three types of the polymer films of FIG. 1 (1)-(3), as graphically drawn on a Poincare sphere.

FIG. 3 (1)-(3) show schematic views of examples of a polymer film of the invention combined with a polarizing element and an example of an ordinary polymer film combined with a polarizing element, to which a linearly-polarized light is applied on the side of the polarizing element.

FIG. 4 (1)-(3) show schematic views of the trace of the polarization state change of the linearly-polarized light running through the three types of the polymer films of FIG. 3 (1)-(3), as graphically drawn on a Poincare sphere.

FIG. 5 shows a schematic view of the trace of the polarization state change of a linearly-polarized light running through an optically-compensatory film having reversed wavelength dispersion characteristics of Re and regular wavelength dispersion characteristics of Rth, as graphically drawn on a Poincare sphere as a reference example.

### PREFERRED EMBODIMENT OF THE INVENTION

The invention is hereunder described in detail. In this specification, numerical value ranges expressed by the term “to” mean that the numerical values described before and after it are included as a lower limit and an upper limit, respectively.

First of all, the terms to be used in the description will be explained.

### [Definitions of Re and Rth]

In the description, Re(λ) (unit: nm) and Rth(λ) (unit: nm) each indicate retardation in plane and retardation along the thickness direction of a sample, a film or the like, at a wavelength λ. Re(λ) is measured by applying a light having a wavelength of λ nm in the normal direction of the film, using KOBRA-21ADH or WR (by Oji Scientific Instruments).

When a film to be tested is represented by an uniaxial or biaxial refractive index ellipsoid, then its Rth(λ) is calculate according to the method mentioned below.

With the in-plane slow axis (determined by KOBRA 21ADH or WR) taken as the inclination axis (rotation axis) of the film (in case where the film has no slow axis, the rotation axis of the film may be in any in-plane direction of the film), Re(λ) of the film is measured at 6 points in all thereof, up to +50° relative to the normal direction of the film at intervals of 10°, by applying a light having a wavelength of λ nm from the inclined direction of the film.

With the in-plane slow axis from the normal direction taken as the rotation axis thereof, when the film has a zero retardation value at a certain inclination angle, then the symbol of the retardation value of the film at an inclination angle larger than that inclination angle is changed to a negative one, and then applied to KOBRA 21ADH or WR for computation.

With the slow axis taken as the inclination axis (rotation axis) (in case where the film has no slow axis, the rotation axis of the film may be in any in-plane direction of the film), the retardation values of the film are measured in any inclined two directions; and based on the data and the mean refractive index and the inputted film thickness, Rth may be calculated according to the following formulae (X) and (XI):

$$\begin{matrix}Re ( θ ) = [ nx - \frac{( ny \times nz )}{\sqrt{\begin{matrix}{\{ ny sin ( {sin}^{- 1} ( \frac{sin ( - θ )}{nx} ) ) \}}^{2} + \\ {\{ nz cos ( {sin}^{- 1} ( \frac{sin ( - θ )}{nx} ) ) \}}^{2}\end{matrix}}} ] \times \frac{d}{cos \{ {sin}^{- 1} ( \frac{sin ( - θ )}{nx} ) \}} \\ & ( X ) \\ Rth = ( \frac{nx + ny}{2} - nz ) \times d & ( XI )\end{matrix}$$

wherein Re(θ) means the retardation value of the film in the direction inclined by an angle θ from the normal direction; nx means the in-plane refractive index of the film in the slow axis direction; ny means the in-plane refractive index of the film in the direction vertical to nx; nz means the refractive index of the film vertical to nx and ny; and d is a thickness of the film.

When the film to be tested can not be represented by a monoaxial or biaxial index ellipsoid, or that is, when the film does not have an optical axis, then its Rth(λ) may be calculated according to the method mentioned below.

With the in-plane slow axis (determined by KOBRA 21ADH or WR) taken as the inclination axis (rotation axis) of the film, Re(λ) of the film is measured at 11 points in all thereof, from −50° to +50° relative to the normal direction of the film at intervals of 10°, by applying a light having a wavelength of λ nm from the inclined direction of the film. Based on the thus-determined retardation data of Re(λ), the mean refractive index and the inputted film thickness, Rth(λ) of the film is calculated with KOBRA21ADH or WR.

The mean refractive index may be used values described in catalogs for various types of optical films. When the mean refractive index has not known, it may be measured with Abbe refractometer. The mean refractive index for major optical film is described below: cellulose acetate (1.48), cycloolefin polymer (1.52), polycarbonate (1.59), polymethylmethacrylate (1.49), polystyrene (1.59).

The mean refractive index and the film thickness are inputted in KOBRA 21ADH or WR, nx, ny and nz are calculated therewith. From the thus-calculated data of nx, ny and nz, Nz=(nx−nz)/(nx−ny) is further calculated.

In the invention, “slow axis” of retardation films and others means the direction in which the refractive index is the largest. “Visible light region” means from 380 nm to 780 nm. Unless otherwise specifically indicated, the refractive index is one measured at λ=550 nm in the visible light region.

In this description, the numerical data, the numerical range and the qualitative expression (for example, “equivalent”, “same”, etc.) indicating the optical properties of constitutive components such as retardation film, liquid-crystal layer and others should be so interpreted as to indicate the numerical data, the numerical range and the qualitative expression that include the error range generally acceptable for liquid-crystal display devices and their constitutive components.

“Regular wavelength dispersion characteristics of Re (or Rth) of a film” means the properties of the film that retardation Re (or Rth) of the film is larger at a shorter wavelength in a visible light region; and on the contrary, “reversed wavelength dispersion characteristics of Re (or Rth) of a film means the properties of the film that retardation Re (or Rth) of the film is smaller at a shorter wavelength in a visible light region. In this description, the retardation data are compared with each other at a wavelength of 550 nm and a wavelength of 450 nm. Regarding Re of a film, for example, when the film satisfies Re(550)/Re(450)≦0.99, then the film exhibits regular wavelength dispersion characteristics of Re; and when the film satisfies Re(550)/Re(450)≧1.01, then the film exhibits reversed wavelength dispersion characteristics of Re. The film with 0.99<Re(550)/Re(450)<1.01 exhibits no wavelength dispersion characteristics regarding Re.

In this description, the refractivity anisotropy of each of the two surfaces of a film is determined according to the method mentioned below.

First, a film sample is left in an atmosphere at a temperature of 25° C. and a relative humidity of 60% for 24 hours. Next, using a prism coupler (Model 2010 Prism Coupler, by Metricon) in an atmosphere at a temperature of 25° C. and a relative humidity of 60%, the film sample is analyzed for the refractive index (n_{TE}) thereof with a polarized light from a 532-nm solid laser in the film plane direction, and for the refractive index (n_{TM}) thereof with the polarized light in the direction normal to the film plane, and the data are introduced into the following formula (XII) to give the mean refractive index (n) of the film through calculation.

n=(n_{TE}×2+n_{TM})/3 (XII)

[wherein n_{TE} means the refractive index of the film measured with the polarized light in the film plane direction, and n_{TM} means the refractive index of the film measured with the polarized light in the direction normal to the film plane].

Next, in an atmosphere at a temperature of 25° C. and a relative humidity of 60%, the film sample is analyzed for the refractive index (n_{TE}^{SA}) in the slow axis direction thereof with a polarized light from the above-mentioned laser in the film plane direction, and for the refractive index (n_{TE}^{FA}) in the fast axis direction thereof with the polarized light in the film plane direction, and the data are introduced into the following formula (XIII) to give the refractivity anisotropy Δn around the two surfaces of the film through calculation respectively.

Δn=n_{TE}^{SA}−n_{TE}^{TFA}

[wherein n_{TE}^{SA} means the refractive index in the slow axis direction of the film measured with the polarized light in the film plane direction, and n_{TE}^{TFA} means the refractive index in the fast axis direction of the film measured with the polarized light in the film plane direction].

### 1. Polymer Film

The polymer film of the invention is characterized in that the wavelength dispersion characteristics of the refractivity anisotropy thereof and/or the refractivity anisotropy thereof differ between two surfaces, surface and rear surface, of the film. The inventors have made assiduous studies and have found that, when one polymer film is made to have a difference in the wavelength dispersion characteristics of the refractivity anisotropy thereof and/or a difference in the refractivity anisotropy thereof between the two surfaces of the film, then the film can exhibit a specific optically-compensatory effect differing from that of an ordinary polymer film with no difference in those properties between the two surfaces thereof, even though Re and Rth are the same as a whole of the film, and have made the present invention. Not requiring lamination of plural films, the invention can achieve a specific optically-compensatory effect, which, however, heretofore could not be realized by an ordinary uniform one-sheet film.

When the difference in the wavelength dispersion characteristics of the refractivity anisotropy (that is, the difference in Re(550)/Re(450)) between the two surfaces of a film is equal to or more than 0.01, then the film can exhibit a specific optically-compensatory effect which differs from that of an ordinary film with no difference in the wavelength dispersion characteristics of the refractivity anisotropy between the two surfaces thereof; and the difference is preferably equal to or more than 0.02, and more preferably equal to or more than 0.03.

When the difference in the refractivity anisotropy between the two surfaces of a film is equal to or more than 0.0002, then the film can exhibit a specific optically-compensatory effect which differs from that of an ordinary film with no difference in the refractivity anisotropy between the two surfaces thereof; and the difference is preferably from 0.0002 to 0.0020, more preferably from 0.0003 to 0.0010.

One embodiment of the polymer film of the invention is a polymer film wherein the reversed wavelength dispersion characteristics of the refractivity anisotropy of one surface of the film are on a higher level than that of the wavelength dispersion characteristics of the refractivity anisotropy of the center part in the thickness direction of the film, and the regular wavelength dispersion characteristics of the refractivity anisotropy of the other surface of the film are on a higher level than that of the wavelength dispersion characteristics of the refractivity anisotropy of the center part in the thickness direction of the film. Specifically, the polymer film has a gradation of wavelength dispersion characteristics of the refractivity anisotropy along the thickness direction thereof. The polymer film of this embodiment can achieve a specific optically-compensatory effect which differs from that of an ordinary polymer film, having the same Re and Rth as those of the polymer film of this embodiment of the invention but not having a difference in the wavelength dispersion characteristics of the refractivity anisotropy between the two surfaces thereof.

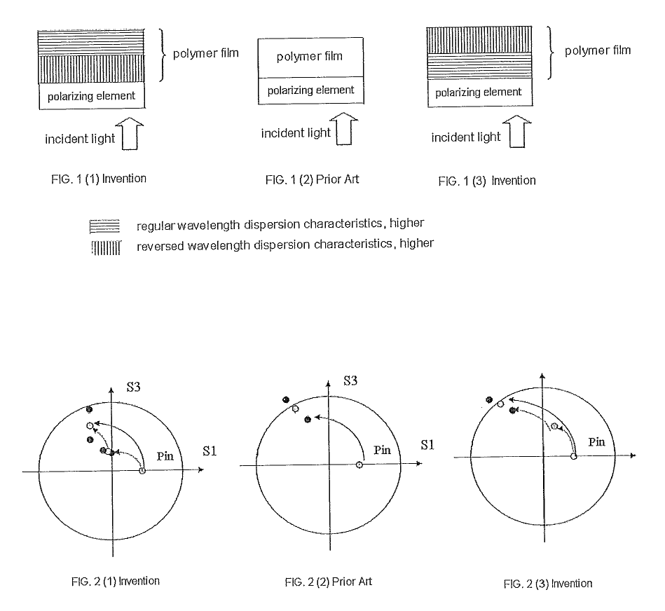

The effect of this embodiment that has a difference in the wavelength dispersion characteristics of the refractivity anisotropy between the two surfaces of the film is described on a Poincare sphere. FIG. 1 schematically show light introduction into polymer films via a polarizing film. The polymer films in FIG. 1 (1) to (3) have the same in-plane retardation (Re) and the same thickness-direction retardation (Rth) at a wavelength of from 430 nm to 700 nm. For example, the films have the same Re at a wavelength of from 430 nm to 700 nm as measured with KOBRA 21ADH or WR (by Oji Scientific Instruments) and have the same Rth calculated from the found data.

The polymer film in FIG. 1 (2) is an ordinary polymer film which does not have a difference in the wavelength dispersion characteristics of the refractivity anisotropy between the two surfaces of the film and of which the wavelength dispersion characteristics of the refractivity anisotropy are uniform in the thickness direction of the film. On the other hand, the polymer films in FIG. 1 (1) and (3) are examples of the polymer film of the invention having a difference in the wavelength dispersion characteristics of the refractivity anisotropy between the two surfaces of the film. In FIG. 1(1), the polymer film is disposed so that its surface having a higher level of reversed wavelength dispersion characteristics of the refractivity anisotropy thereof is on the side that faces the polarizing element; and in FIG. 1(3), the polymer film is disposed so that its surface having a higher level of regular wavelength dispersion characteristics of the refractivity anisotropy thereof is on the side that faces the polarizing element. For the purpose of expressing this condition and for the purpose of simplifying the description, the polymer films in FIG. 1, (1) and (3) are schematically shown as two-layered films each comprising a layer having a higher level of reversed wavelength dispersion characteristics of the refractivity anisotropy thereof and a layer having a higher level of regular wavelength dispersion characteristics of the refractivity anisotropy thereof. In these, the in-plane slow axis of the polymer film is perpendicular to the absorption axis of the polarizing element.

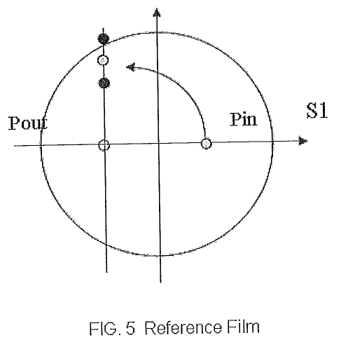

FIG. 2 (1) to (3) are schematic views showing the trace of the polarization state change of the linearly-polarized light that runs through the polymer film after having passed through the polarizing element in FIG. 1 (1) to (3), as graphically drawn as a solid line on a Poincare sphere. The viewing direction is at a polar angle of 60° and at an azimuth angle of 45°. In the drawings, the point “Pin” indicates the state of the linearly-polarized light having passed through the polarizing element. The dotted lines in FIG. 2 (1) and (3) each are the trace of the polarization state change of the linearly-polarized light running through the constitutive layers of the polymer film on the virtual presumption that the polymer film is composed of two layers differing from each other in the wavelength dispersion characteristics of the refractivity anisotropy thereof as in FIG. 1 (1) and (3). As in FIG. 2 (1) and (3), the trace of the polarization state change of the linearly-polarized light that runs through the polymer film having a difference in the wavelength dispersion characteristics of the refractivity anisotropy between the two surfaces of the film differs from the trace of the polarization state change of the linearly-polarized light that runs through the ordinary polymer film having uniform wavelength dispersion characteristics of the refractivity anisotropy along the thickness direction of the film shown in FIG. 2(2). From FIG. 2, it is understood that the polymer film of this embodiment of the invention exhibits a specific optically-compensatory effect differing from that of the ordinary polymer film having uniform wavelength dispersion characteristics of the refractivity anisotropy thereof even though Re and Rth of the polymer film of the invention are the same as those of the ordinary polymer film as a whole of the film. In particular, as in FIG. 1(1), when the polymer film of this embodiment of the invention is so disposed that its surface having a higher level of reversed wavelength dispersion characteristics of the refractivity anisotropy of the film is on the side facing the polarizing element adjacent thereto, then one sheet of this polymer film can achieve nearly the same effect as that of a polymer film having reversed wavelength dispersion characteristics of Re and having regular wavelength dispersion characteristics of Rth, as in FIG. 2(1). For reference, FIG. 5 (in the drawing, the point “Pin” indicates the state of the linearly-polarized light having passed through the polarizing element; and the point “Pout” indicates the polarization state at an extinction point) shows a schematic view of the trace of the polarization state change of a linearly-polarized light running through a film having reversed wavelength dispersion characteristics of Re and regular wavelength dispersion characteristics of Rth, as graphically drawn on a Poincare sphere.

Another embodiment of the polymer film of the invention is a polymer film of such that the refractivity anisotropy of one surface of the film is larger than the refractivity anisotropy of the center part in the thickness direction of the film, and that the refractivity anisotropy of the other surface of the film is smaller than the refractivity anisotropy of the center part in the thickness direction of the film. Specifically, the polymer film has a refractivity anisotropy gradation in the thickness direction thereof. The polymer film of this embodiment can attain a specific optically-compensatory effect which differs from that of an ordinary polymer film not having a difference in the refractivity anisotropy thereof but having the same Re and Rth as those of the polymer film of this embodiment of the invention.

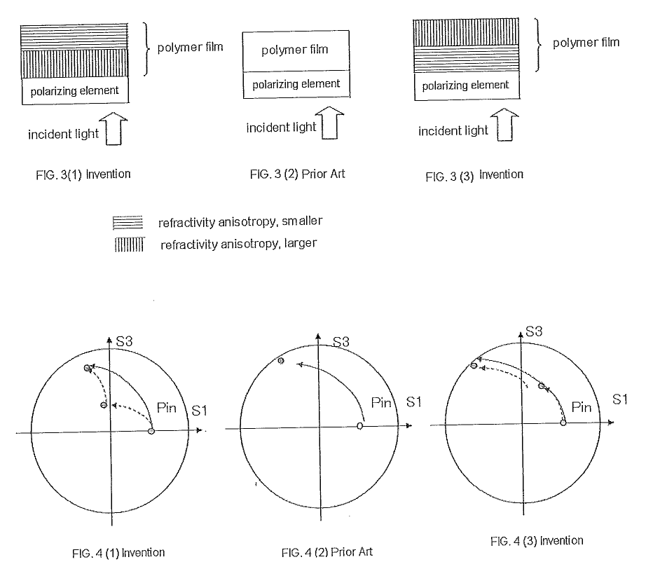

The effect of this embodiment that has a difference in the refractivity anisotropy between the two surfaces of the film is described on a Poincare sphere. FIG. 3 schematically show light introduction into polymer films via a polarizing film. The polymer films in FIG. 3, (1) to (3) have the same in-plane retardation (Re) and the same thickness-direction retardation (Rth). For example, the films have the same Re as measured with KOBRA 21ADH or WR (by Oji Scientific Instruments) and have the same Rth computed from the found data.

The polymer film in FIG. 3(2) is an ordinary polymer film which does not have a difference in the refractivity anisotropy between the two surfaces of the film. On the other hand, the polymer films in FIG. 3(1) and (3) are examples of the polymer film of the invention having a difference in the refractivity anisotropy between the two surfaces of the film. In FIG. 3(1), the polymer film is disposed that its surface having a larger refractivity anisotropy is on the side that faces the polarizing element; and in FIG. 3(3), the polymer film is disposed so that its surface having a smaller refractivity anisotropy is on the side that faces the polarizing element. For the purpose of expressing this condition and for the purpose of simplifying the description, the polymer films in FIG. 3 (1) and (3) are schematically shown as two-layered films each comprising a layer having a larger refractivity anisotropy and a layer having a smaller refractivity an isotropy. In these, the in-plane slow axis of the polymer film is perpendicular to the absorption axis of the polarizing element.

FIG. 4 (1) to (3) are schematic views showing the trace of the polarization state change of the linearly-polarized light that runs through the polymer film after having passed through the polarizing element in FIG. 3 (1) to (3), as graphically drawn as a solid line on a Poincare sphere. The viewing direction is at a polar angle of 60° and at an azimuth angle of 45°. In the drawings, the point “Pin” indicates the state of the linearly-polarized light having passed through the polarizing element The dotted lines in FIG. 4 (1) and (3) each are the trace of the polarization state change of the linearly-polarized light running through the constitutive layers of the polymer film on the virtual presumption that the polymer film is composed of two layers differing from each other in the refractivity anisotropy thereof as in FIG. 3 (1) and (3). As in FIG. 4 (1) and (3), the trace of the polarization state change of the linearly-polarized light that runs through the polymer film having a difference in the refractivity anisotropy between the two surfaces of the film differs from the trace of the polarization state change of the linearly-polarized light that runs through the ordinary polymer film having uniform refractivity anisotropy in the thickness direction of the film shown in FIG. 4(2). From FIG. 4, it is understood that the polymer film of this embodiment of the invention exhibits a specific optically-compensatory effect differing from that of the ordinary polymer film having uniform refractivity anisotropy even though Re and Rth of the polymer film of the invention are the same as those of the ordinary polymer film as a whole of the film.

Next described is a method for producing the polymer film of the invention.

The polymer film of the invention can be produced by stretching a film which is prepared according to a solvent casting method. According to this production process, it is possible to carry out the film forming step and the stretching step continuously. Therefore, this process is suitable to continuous industrial-scale production of the polymer film of the invention.

The material for the polymer film of the invention may be selected from various polymer materials from the viewpoint of the optical properties, the transparency, the mechanical strength, the thermal stability, the moisture-blocking capability and the anisotropy of the film produced. Examples of the material include polycarbonate-type polymer, polyester-type polymer such as polyethylene terephthalate and polyethylene naphthalate, acrylic polymer such as polymethyl methacrylate, and styrenic polymer such as polystyrene and acrylonitrile/styrene copolymer (AS resin). In addition, examples thereof also include polyolefin-type polymers such as polyethylene, polypropylene and ethylene/propylene copolymers; vinyl chloride-type polymer; amide-type polymer such as nylon and aromatic polyamide; imide-type polymer, sulfone-type polymer, polyether sulfone-type polymer, polyether-ether ketone-type polymer, polyphenylene sulfide-type polymer, vinylidene chloride-type polymer, vinyl alcohol-type polymer, vinyl butyral-type polymer, arylate-type polymer, polyoxymethylene-type polymer, epoxy-type polymer; and mixed polymer of the above polymers.

As the material to form the polymer film, preferably used is a thermoplastic norbornene-type resin. The thermoplastic norbornene-type resin includes Nippon Zeon's ZEONEX and ZEONOR, and JSR's ARTON, etc.

As the material to form the polymer film, especially preferred is a cellulose polymer heretofore used as a transparent protective film for polarizing plate (hereinafter this may be referred to as cellulose acylate).

The cellulose acylate film which can be used in the invention will be described hereinafter.

One typical example of cellulose acylate is triacetyl cellulose. The cellulose material for cellulose acylate includes cotton liter and wood pulp (hardwood pulp, softwood pulp), and cellulose acylate obtained from any such cellulose material is usable herein. As the case may be, those cellulose materials may be mixed for use herein. The cellulose materials are described in detail, for example, in Marusawa & Uda's “Plastic Material Lecture (17), Cellulose Resin” by Nikkan Kogyo Shinbun (1970) and Hatsumei Kyokai's Disclosure Bulletin 2001-1745 (pp. 7-8), and those celluloses described therein may be usable herein. There should not be any specific limitation to the cellulose acylate film for use in the invention.

The degree of substitution of cellulose acylate means the degree of acylation of three hydroxyl groups existing in the constitutive unit ((β)1,4-glycoside-bonding glucose) of cellulose. The degree of substitution (degree of acylation) may be computed by measuring the bonding fatty acid amount per the constitutive unit mass of cellulose. The determination may be carried out according to “ASTM D817-91”.

The cellulose acylate to be used as the polymer film of the invention is cellulose acetate having a degree of acetyl substitution of from 2.50 to 3.00. More preferably, the degree of acetyl substitution is from 2.70 to 2.97. The cellulose acylate may have an acyl group other than acetyl along with acetyl or in place of acetyl. Cellulose acylates having at least one selected from the group consisting of acetyl, propionyl, and butyryl are preferable; and cellulose acylates having at least two selected from the group consisting of acetyl, propionyl, and butyryl are more preferable.

Preferably, the cellulose acylate has a mass-average degree of polymerization of from 350 to 800, more preferably from 370 to 600. Also preferably, the cellulose acylate for use in the invention has a number-average molecular weight of from 70000 to 230000, more preferably from 75000 to 230000, even more preferably from 78000 to 120000.

The cellulose acylate may be produced, using an acid anhydride or an acid chloride as the acylating agent for it. One most general production method for producing the cellulose acylate on an industrial scale comprises esterifying cellulose obtained from cotton linter, wood pulp or the like with a mixed organic acid component comprising an organic acid corresponding to an acetyl group and other acyl group (acetic acid, propionic acid, butyric acid) or its acid anhydride (acetic anhydride, propionic anhydride, butyric anhydride).

The polymer film of the invention is a film which is prepared according to a solvent-casting method. More specifically, the polymer film of the invention may be prepared as follows. A dope is prepared by dissolving the ingredients such as a polymer in an organic solvent, cast on the surface of a metal support (band), and dried to form a film. After that, the film may be removed from the support and then may be stretched. When embodiments of the polymer film containing a refractivity-anisotropy material, which will be described in detail later, are prepared, the refractivity-anisotropy material may be added to the dope. The dope may be prepared by adding the polymer material and additive(s) such as the refractivity-anisotropy material to the dope at once, or may be prepared by mixing the dope of the polymer material with the dope of the additive which is prepared separately.

Examples of production of cellulose acylate films according to a solvent-casting method are given in U.S. Pat. Nos. 2,336,310, 2,367,603, 2,492,078, 2,492,977, 2,492,978, 2,607,704, 2,739,069 and 2,739,070; British Patent Nos. 640731 and 736892; JP-B Nos. syo 45-4554 and syo 49-5614; and JP-A Nos. syo 60-176834, syo 60-203430, and syo 62-115035, and their descriptions are referred to herein.

After the film forming process, the cellulose acylate film is stretched. The ratio of stretching is preferably from 3 to 100%. The stretching treatment may be carried out by using a tenter. The stretching treatment may be carried out also by using two rolls to be fed the film therebetween.

Regarding the method and condition for stretching treatment, for example, referred to are JP-A Nos. syo 62-115035, hei 4-152125, hei 4-284511, hei 4-298310, and hei 11-48271.

The polymer film of the invention is characterized in that the wavelength dispersion characteristics of the refractivity anisotropy thereof and/or the refractivity anisotropy thereof differ between two surfaces of the film. This property may be achieved according to various methods. One example is adding a refractivity anisotropic material having larger reversed or regular wavelength dispersion characteristics compared with that of the polymer material to be used as a main ingredient of the film. The polymer film, containing such a refractivity anisotropic material whose concentration differs between the two surfaces thereof, may show wavelength dispersion characteristics of the refractivity anisotropy differing between the two surfaces thereof. Another example is adding both of materials having reversed and regular wavelength dispersion characteristics to the film. The polymer film, containing such two materials at least one of which concentration differs between the two surfaces thereof, shows wavelength dispersion characteristics of the refractivity anisotropy differing between the two surfaces thereof. The definitions of the terms “material having reversed wavelength dispersion characteristics” and “material having regular wavelength dispersion characteristics” are as follows. As a comparison film, a stretched film, having no wavelength dispersion characteristics of Re, that is, satisfying 0.99<Re(450)/Re(550)<1.01, is prepared. Separately, a sample film is prepared in the same manner as the comparison film, except that a certain material is added thereto. If the sample film shows reversed wavelength dispersion characteristics of Re, then the material added to the film is defined as a material having reversed wavelength dispersion characteristics; on the other hand, if the sample film shows regular wavelength dispersion characteristics of Re, then the material added to the film is defined as a material having regular wavelength dispersion characteristics. Some polymer films such as a cellulose acylate film naturally show reversed wavelength dispersion characteristics of Re when being subjected to a stretching treatment. Using such a polymer film as a comparison film, if the sample film, which is prepared in the same manner as the comparison film, except that a certain material is added thereto, shows larger reversed wavelength dispersion characteristics of Re compared with that of the comparison film, then the material added to the film is defined as a material having reversed wavelength dispersion characteristics; on the other hand, if the sample film shows smaller reversed wavelength dispersion characteristics of Re compared with that of the comparison film, then the material added to the film is defined as a material having regular wavelength dispersion characteristics. According to the same manner, when a stretched polymer film, showing regular wavelength dispersion characteristics of Re, is used as a comparison film, it is also possible to define the material added to the film as “a material having reversed wavelength dispersion characteristics” or “a material having regular wavelength dispersion characteristics”. In the description, “larger reversed wavelength dispersion characteristics” means that the value of Δn(550)/Δn(450) is larger by 0.01 or more; and, on the other hand, “larger regular wavelength dispersion characteristics” means that the value of Δn(550)/Δn(450) is smaller by 0.01 or more.

For the embodiments using both of materials having reversed and regular wavelength dispersion characteristics, they may be selected from various materials so that their compatibilities with the polymer material (main ingredient) to be used along with them, are good; and they may be selected from various materials so that their compatibilities with the organic solvent to be used for preparing the dope and volatile properties are different from each other. In the embodiments, the dope may be prepared by using such materials, cast on a surface of a support (for example, a band), and then dried under a condition. By adjusting the condition in the drying step, it is possible to prepare a polymer film containing the materials whose concentrations differ between the two surfaces thereof. More specifically, materials having reversed and regular wavelength dispersion characteristics may be selected from various materials so that their compatibilities with the organic solvent to be used for preparing the dope are different from each other. Then the dope may be prepared by using the materials, cast on a surface of a support (for example, a band), and then dried under a condition to evaporate the solvent. At that time, the condition in the drying step may be decided so that the situation in which the concentration of the solvent is graded along the thickness direction of the film is kept for a period sufficient for allowing the concentrations of the materials to be graded along the thickness direction of the film due to the difference in their compatibilities with the solvent. By carrying out the drying step under such a condition, a polymer film containing the materials whose concentrations differ between the two surfaces thereof can be prepared. For example, by heating rapidly only one interface of the film with the air or the support, the concentration of the solvent may be graded along the thickness direction of the film. By keeping such a situation for a certain period, the concentration(s) of the material(s) having reversed and/or regular wavelength dispersion characteristics may be also graded along the thickness direction of the film. According to this method, it is possible to prepare not only a polymer film containing the materials whose concentrations differ between the two surfaces thereof but also a polymer film containing the materials whose concentrations are graded along the film thickness as a whole. Furthermore, by allowing the solvent residue amount to be graded along the thickness direction of the film in carrying out the stretching step, the degree of the orientation of polymer molecules in the stretched film may be graded along the thickness direction of the film. In this embodiment, before carrying out the stretching step, the above mentioned method, that is, method for allowing the solvent residue amount in the non-peeled film to differ between the two surfaces thereof may be carried out. Or, during the stretching step, dry air may be applied to the two surfaces of the film at different flow velocities respectively or at different temperatures respectively so that the solvent residue amount is graded along the thickness direction of the film in carrying out the stretching step.

The polymer material, a main ingredient of the film, has refractivity anisotropy, and therefore, a polymer film in which the density of the polymer material differs between the two surfaces thereof is one examples of the polymer film of the invention whose refractivity anisotropy differs between the two surfaces thereof. For example, the dope may be cast on a surface of a support (for example, a band), and then dried under a condition to evaporate the solvent. At that time, the condition in the drying step may be decided so that the situation in which the concentration of the solvent is graded along the thickness direction of the film is kept for a period sufficient for allowing the density or the degree of the orientation of the polymer material to be graded along the thickness direction of the film. By carrying out the drying step under such a condition, refractivity anisotropy of the polymer film differs between the two surfaces thereof due to the difference(s) in the density and/or the degree of orientation of the polymer material. According to this method, it is possible to prepare not only a polymer film whose refractivity anisotropy differs between the two surfaces thereof but also a polymer film whose refractivity anisotropy is graded along the film thickness as a whole. Furthermore, a polymer film of the invention may be prepared according to a co-solvent casting method using plural types of dopes (for example, dopes for forming surface, center and rear layers) having a formulation in which the concentration(s) of the additive(s) such as the materials having reversed and regular wavelength dispersion characteristics is different from each other. According to this method, it is possible to prepare a polymer film containing the additive(s) whose concentration(s) is graded between the two surfaces of the film.

Or, the polymer film of the invention whose refractive anisotropy differs between the two surfaces thereof may be prepared by adding a refractive anisotropy material other than the polymer material, a main ingredient, to the film. For example, a polymer film, containing a refractivity anisotropy material having larger refractivity anisotropy compared with the polymer material (main ingredient), of which concentration and/or the degree of orientation of the material differing between the two surfaces of the film, is one example of the polymer film of the invention whose refractivity anisotropy differs between the two surfaces thereof. Examples of the method for allowing the concentration of a refractivity anisotropy material to be graded along the thickness direction of the film are same as described above.

Examples of the material having reversed wavelength dispersion characteristics include compounds represented by formula (A). The material is preferably selected form the compounds showing the liquid crystallinity.

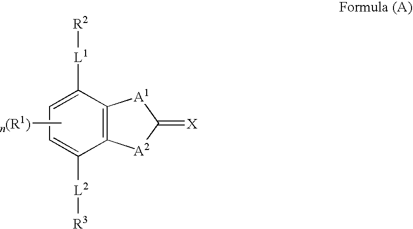

In the formula, L¹ and L² independently represent a single bond or a divalent linking group; A¹ and A² independently represent a group selected from the group consisting of —O—,—NR— where R represents a hydrogen atom or a substituent, —S— and —CO—;R¹, R² and R³ independently represent a substituent; X represents a nonmetal atom selected from the groups 14-16 atoms, provided that X may bind with at least one hydrogen atom or substituent; and n is an integer from 0 to 2.

Among the compounds represented by the formula (A), the compounds represented by the formula (B) are preferred as a retardation enhancer.

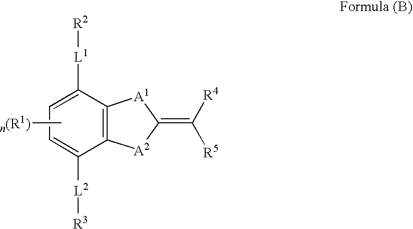

In the formula (B), L¹ and L² independently represent a single bond or a divalent group. A¹ and A² independently represent a group selected from the group consisting of —O—,—NR— where R represents a hydrogen atom or a substituent, —S— and —CO—. R¹, R² and R³ independently represent a substituent. And n is an integer from 0 to 2.

Preferred examples of the divalent linking group represented by L¹ or L² in the formula (A) or (B) include those shown below.

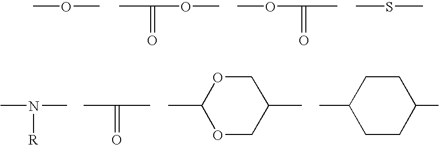

And further preferred are —O—, —COO— and —OCO—.

In the formulae (A) and (B), R¹ represents a substituent, if there are two or more R, they may be same or different from each other, or form a ring. Examples of the substituent include those shown below.

Halogen atoms such as fluorine, chlorine, bromine and iodine atoms; alkyls (preferably C₁₋₃₀ alkyls) such as methyl, ethyl, n-propyl, iso-propyl, tert-butyl, n-octyl, and 2-ethylhexyl; cylcoalkyls (preferably C₃₋₃₀ substituted or non-substituted cycloalkyls) such as cyclohexyl, cyclopentyl and 4-n-dodecylcyclohexyl; bicycloalkyls (preferably C₅₋₃₀ substitute or non-substituted bicycloalkyls, namely monovalent residues formed from C₅₋₃₀ bicycloalkanes from which a hydrogen atom is removed) such as bicyclo[1,2,2]heptane-2-yl and bicyclo[2,2,2]octane-3-yl; alkenyls (preferably C₂₋₃₀ alkenyls) such as vinyl and allyl; cycloalkenyls (preferably C₃₋₃₀ substituted or non-substituted cycloalkenyls, namely monovalent residues formed from C₃₋₃₀ cycloalkenes from which a hydrogen atom is removed) such as 2-cyclopentene-1-yl and 2-cyclohexene-1-yl; bicycloalkenyls (preferably C₅₋₃₀ substituted or non-substituted bicycloalkenyls, namely monovalent residues formed from C₅₋₃₀ bicycloalkenes from which a hydrogen atom is removed) such as bicyclo[2,2,1]hepto-2-en-1-yl and bicyclo[2,2,2]octo-2-en-4-yl; alkynyls (preferably C₂₋₃₀ substitute or non-substituted alkynyls) such as etynyl and propargyl; aryls (preferably C₆₋₃₀ substitute or non-substituted aryls) such as phenyl, p-tolyl and naphthyl; heterocyclic groups (preferably (more preferably C₃₋₃₀) substituted or non-substituted, 5-membered or 6-membered, aromatic or non-aromatic heterocyclic monovalent residues) such as 2-furyl, 2-thienyl, 2-pyrimidinyl and 2-benzothiazolyl; cyano, hydroxyl, nitro, carboxyl, alkoxys (preferably C₁₋₃₀ substituted or non-substituted alkoxys) such as methoxy, ethoxy, iso-propoxy, t-butoxy, n-octyloxy and 2-methoxyethoxy; aryloxys (preferably C₆₋₃₀ substituted or non-substituted aryloxys) such as phenoxy, 2-methylphenoxy, 4-t-butylphenoxy, 3-nitrophenoxy and 2-tetradecanoyl aminophenoxy; silyloxys (preferably C₃₋₂₀ silyloxys) such as trimethylsilyloxy and t-butyidimethylsilyloxy; hetero-cyclic-oxys (preferably C₂₋₃₀ substituted or non-substituted hetero-cyclic-oxys) such as 1-phenyltetrazole-5-oxy and 2-tetrahydropyrenyloxy; acyloxys (preferably C₂₋₃₀ substitute or non-substituted alkylcarbonyloxys and C₆₋₃₀ substituted or non-substituted arylcarbonyloxys) such as formyloxy, acetyloxy, pivaloyloxy, stearoyoxy, benzoyloxy and p-methoxyphenylcarbonyloxy; carbamoyloxys (preferably C₁₋₃₀ substituted or non-substituted carbamoyloxys) such as N,N-dimethyl carbamoyloxy, N,N-diethyl carbamoyloxy, morpholinocarbonyloxy, N,N-di-n-octylaminocarbonyloxy and N-n-octylcarbamyloxy; alkoxy carbonyloxys (preferably C₂₋₃₀ substituted or non-substituted alkoxy carbonyloxys) such as methoxy carbonyloxy, ethoxy carbonyloxy, t-butoxy carbonyloxy and n-octyloxy carbonyloxy; aryloxy carbonyloxys (preferably C₇₋₃₀ substituted or non-substituted aryloxy carbonyloxys) such as phenoxy carbonyloxy, p-methoxyphenoxy carbonyloxy and p-n-hexadecyloxyphenoxy carbonyloxy; aminos (preferably C₀₋₃₀ substituted or non-substituted alkylaminos and C₆₋₃₀ substituted or non-substituted arylaminos) such as amino, methylamino, dimethylamino, anilino, N-methyl-anilino and diphenylamino; acylaminos (preferably C₁₋₃₀ substituted or non-substituted alkylcarbonylaminos and C₆₋₃₀ substituted or non-substituted arylcarbonylaminos) such as formylamino, acetylamino, pivaloylamino, lauroylamino and benzoylamino; aminocarbonylaminos (preferably C₁₋₃₀ substituted or non-substituted aminocarbonylaminos) such as carbamoylamino, N,N-dimethylaminocarbonylamino, N,N-diethylamino carbonylamino and morpholino carbonylamino; alkoxycarbonylaminos (preferably C₂₋₃₀ substituted or non-substituted alkoxycarbonylaminos) such as methoxycarbonylamino, ethoxycarbonylamino, t-butoxycarbonylamino, n-octadecyloxycarbonylamino and N-methyl-methoxy carbonylamino; aryloxycarbonylaminos (preferably C₇₋₃₀ substituted or non-substituted aryloxycarbonylaminos) such as phenoxycarbonylamino, p-chloro phenoxycarbonylamino and m-n-octyloxy phenoxy carbonylamino; sulfamoylaminos (preferably C₀₋₃₀ substituted or non-substituted sulfamoylaminos) such as sulfamoylamino, N,N-dimethylamino sulfonylamino and N-n-octylamino sulfonylamino; alkyl- and aryl-sulfonylaminos (preferably C₁₋₃₀ substituted or non-substituted alkyl-sulfonylaminos and C₆₋₃₀ substituted or non-substituted aryl-sulfonylaminos) such as methyl-sulfonylamino, butyl-sulfonylamino, phenyl-sulfonylamino, 2,3,5-trichlorophenyl-sulfonylamino and p-methylphenyl-sulfonylamino; mercapto; alkylthios (preferably substituted or non-substituted C₁₋₃₀ alkylthios such as methylthio, ethylthio and n-hexadecylthio; arylthios (preferably C₆₋₃₀ substituted or non-substituted arylthios) such as phenylthio, p-chlorophenylthio and m-methoxyphenylthio; heterocyclic-thios (preferably C₂₋₃₀ substituted or non-substituted heterocyclic-thios such as 2-benzothiazolyl thio and 1-phenyltetrazol-5-yl-thio; sulfamoyls (preferably C₀₋₃₀ substituted or non-substituted sulfamoyls) such as N-ethylsulfamoyl, N-(3-dodecyloxypropyl)sulfamoyl, N,N-dimethylsulfamoyl, N-acetylsulfamoyl, N-benzoylsulfamoyl, N-(N′-phenylcarbamoyl)sulfamoyl; sulfo; alkyl- and aryl-sulfinyls (preferably C₁₋₃₀ substituted or non-substituted alkyl- or C₆₋₃₀ substituted or non-substituted aryl-sulfinyls) such as methylsulfinyl, ethylsulfinyl, phenylsulfinyl and p-methylphenylsulfinyl; alkyl- and aryl-sulfonyls (preferably C₁₋₃₀ substituted or non-substituted alkyl-sulfonyls and C₆₋₃₀ substituted or non-substituted arylsulfonyls) such as methylsulfonyl, ethylsulfonyl, phenylsulfonyl and p-methylphenylsulfonyl; acyls (preferably C₂₋₃₀ substituted non-substituted alkylcarbonyls, and C₇₋₃₀ substituted or non-substituted arylcarbonyls) such as formyl, acetyl and pivaloyl benzyl; aryloxycarbonyls (preferably C₇₋₃₀ substituted or non-substituted aryloxycarbonyls) such as phenoxycarbonyl, o-chlorophenoxycarbonyl, m-nitrophenoxycarbonyl and p-t-butylphenoxycarbonyl; alkoxycarbonyls (preferably C₂₋₃₀ substituted or non-substituted alkoxycarbonyls) methoxycarbonyl, ethoxycarbonyl, t-butoxycarbonyl and n-octadecyloxycarbonyl; carbamoyls (preferably C₁₋₃₀ substituted or non-substituted carbamoyls) such as carbamoyl, N-methylcarbamoyl, N,N-dimethylcarbamoyl, N,N-di-n-octylcarbamoyl and N-(methylsulfonyl)carbamoyl; aryl- and heterocyclic-azos (preferably C₆₋₃₀ substituted or non-substituted arylazos and C₃₋₃₀ substituted or non-substituted heterocyclicazos) such as phenylazo and p-chlorophenylazo, 5-ethylthio-1,3,4-thiadiazol-2-yl-azo, imides such as N-succinimide and N-phthalimide; phosphinos (preferably C₂₋₃₀ substituted or non-substituted phosphinos) such as dimethyl phosphino, diphenyl phosphino and methylphenoxy phosphino; phosphinyls (preferably C₂₋₃₀ substituted or non-substituted phosphinyls) such as phosphinyl, dioctyloxy phosphinyl and diethoxy phosphinyl; phosphinyloxys (preferably C₂₋₃₀ substituted or non-substituted phosphinyloxys) such as diphenoxyphosphinyloxy and dioctyloxyphosphinyloxy; phosphinylaminos (preferably C₂₋₃₀ substituted or non-substituted phosphinylaminos) such as dimethoxy phosphinylamino and dimethylamino phosphinylamino; and silyls (preferably C₃₋₃₀ substituted or non-substituted silyls) such as trimethylsilyl, t-butylmethylsilyl and phenyidimethylsilyl.

The substituents, which have at least one hydrogen atom, may be substituted by at least one substituent selected from these. Examples such substituent include alkylcarbonylaminosulfo, arylcarbonylaminosulfo, alkylsulfonylaminocarbonyl and aryIsulfonylaminocarbonyl. More specifically, methylsulfonylaminocarbonyl, p-methylphenylsulfonylaminocarbonyl, acetylaminosulfonyl and benzoylaminosulfonyl are exemplified.

Preferably, R¹ represents a hydrogen atom, an alkyl group, an alkenyl group, an aryl group, a heterocyclic group, hydroxyl, carboxyl, an alkoxy group, an acyloxy group, cyano or an amino group; and more preferably, a halogen atom, an alkyl group, cyano or an alkoxy group.

R² and R³ independently represent a substituent. Examples of the substituent include those exemplified above as examples of R¹. Preferably, R² and R³ independently represent a substituted or non-substituted phenyl or a substituted or non-substituted cyclohexyl; more preferably, a substituted phenyl or a substituted cyclohexyl; and much more preferably, a phenyl having a substituent at a 4-position or a cyclohexyl having a substituent at a 4-position.

R⁴ and R⁵ independently represent a substituent. Examples of the substituent include those exemplified above as examples of R¹. Preferably, R⁴ and R⁵ independently represent an electron-attractant group having the Hammett value, σₚ, more than 0; more preferably an electron-attractant group having the Hammett value, σₚ, from 0 to 1.5. Examples of such an electron-attractant group include trifluoromethyl, cyano, carbonyl and nitro. R⁴ and R⁵ may bind to each other to form a ring.

It is to be noted that, regarding Hammett constant of the substituent, σₚ and σₘ, there are detailed commentaries on the Hammett constant of the substituent, σₚ and σₘ in “Hammett Rule-Structure and Reactivity-(Hammeto soku-Kozo to Hanohsei)” published by Maruzen and written by Naoki Inamoto; “New Experimental Chemistry 14 Synthesis and Reaction of Organic Compound V (Shin Jikken Kagaku Koza 14 Yuuki Kagoubutsu no Gousei to Hannou)” on p. 2605, edited by Chemical Society of Japan and published by Maruzen; “Theory Organic Chemistry Review (Riron Yuuki Kagaku Gaisetsu)” on p. 217, published by TOKYO KAGAKU DOZIN CO. LTD., and written by Tadao Nakatani; and Chemical Reviews, Vol. 91, No. 2, pp. 165-195(1991).

In the formula, A¹ and A² independently represent a group selected from the group consisting of —O—, —NR— where R represents a hydrogen atom or a substituent, —S— and —CO—; and preferably, —O—, —NR— where R represents a substituent selected from those exemplified above as examples of R¹, or —S—.

In the formula, X represents a nonmetal atom selected from the groups 14-16 atoms, provided that X may bind with at least one hydrogen atom or substituent. Preferably, X represents ═O, ═S, ═NR or ═C(R)R where R represents a substituent selected from those exemplified as examples of R¹.

In the formula, n is an integer from 0 to 2, and preferably 0 or 1.

Examples of the compound represented by the formula (A) or (B) include, but examples of the material having reversed wavelength dispersion characteristics are not limited to, those shown below. Regarding the compounds shown below, each compound to which is appended (X) is referred to as “Compound (X)” unless it is specified.

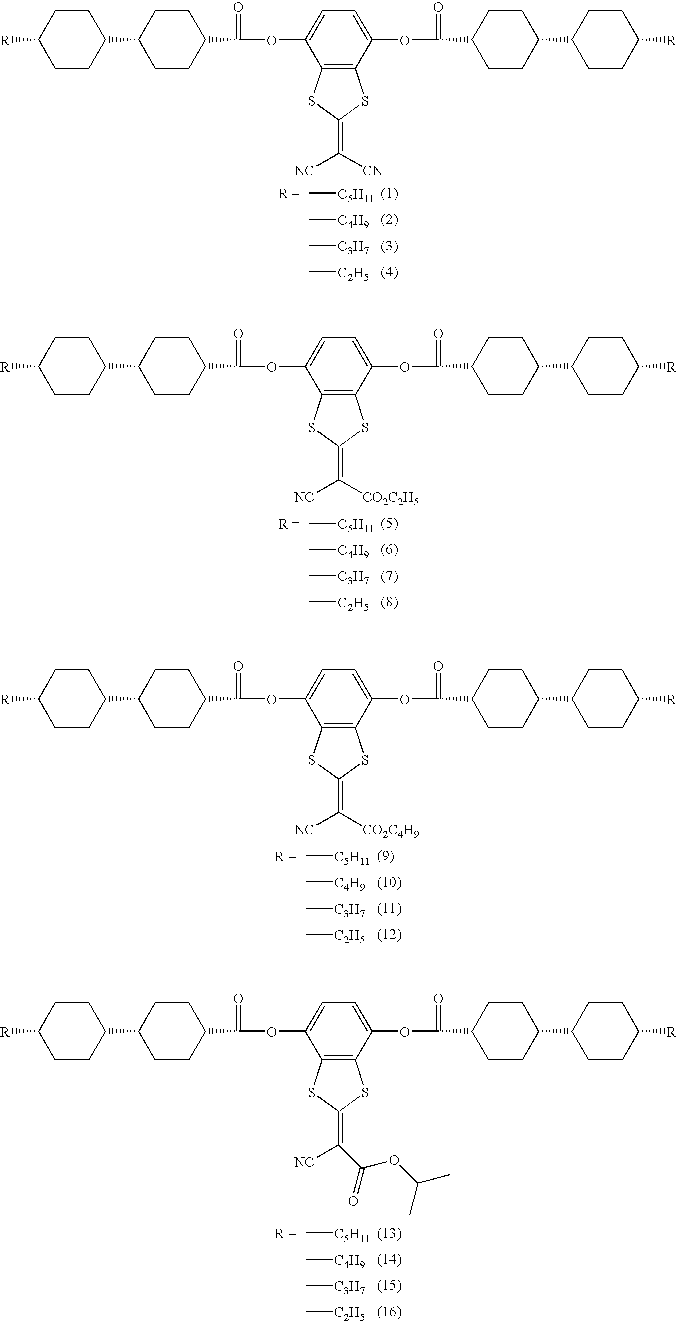

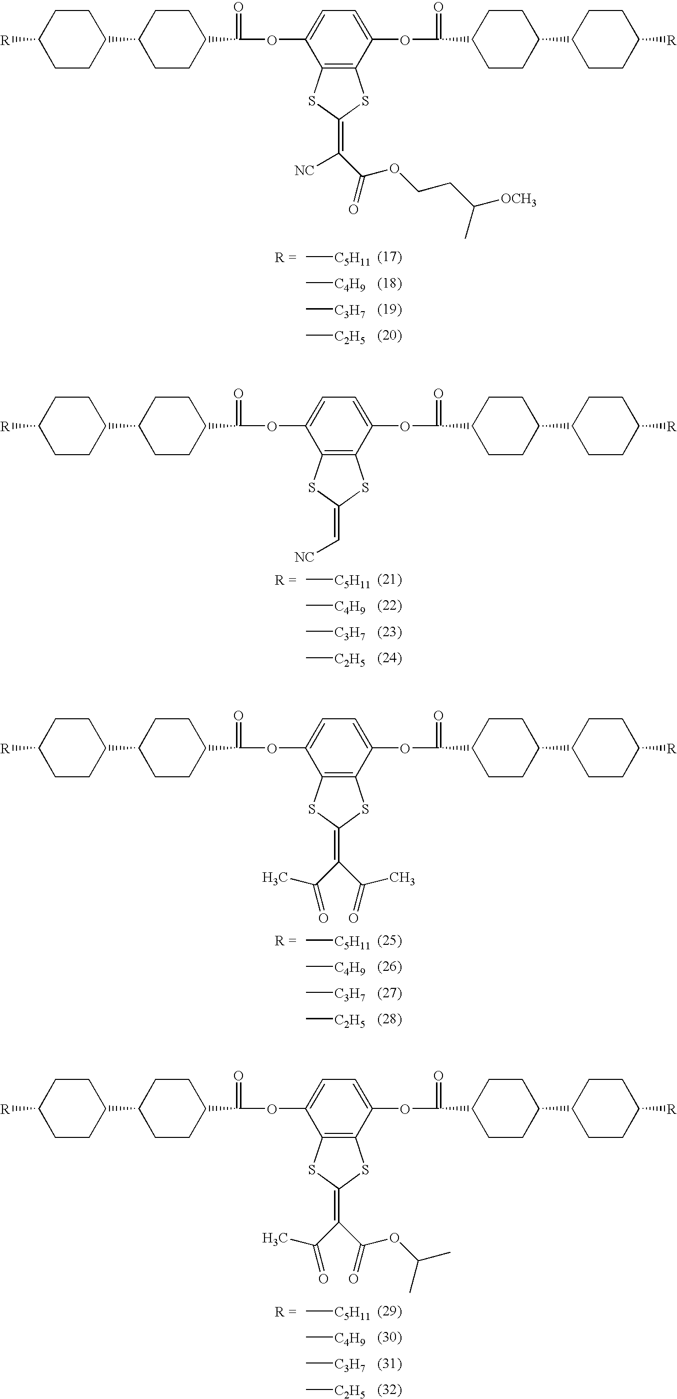

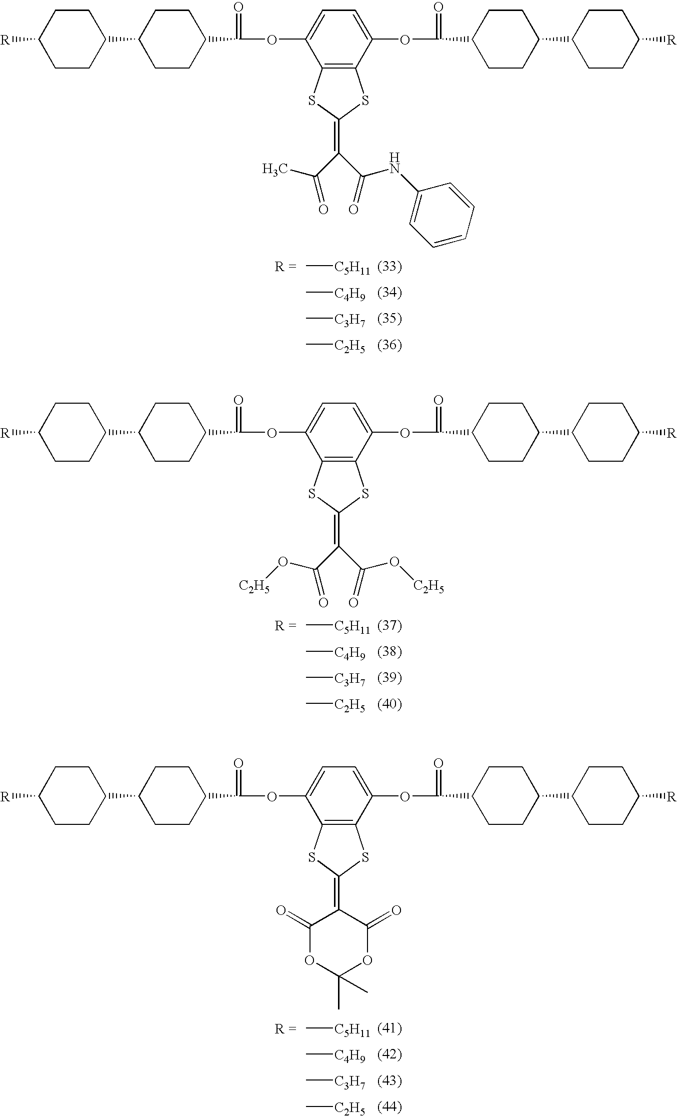

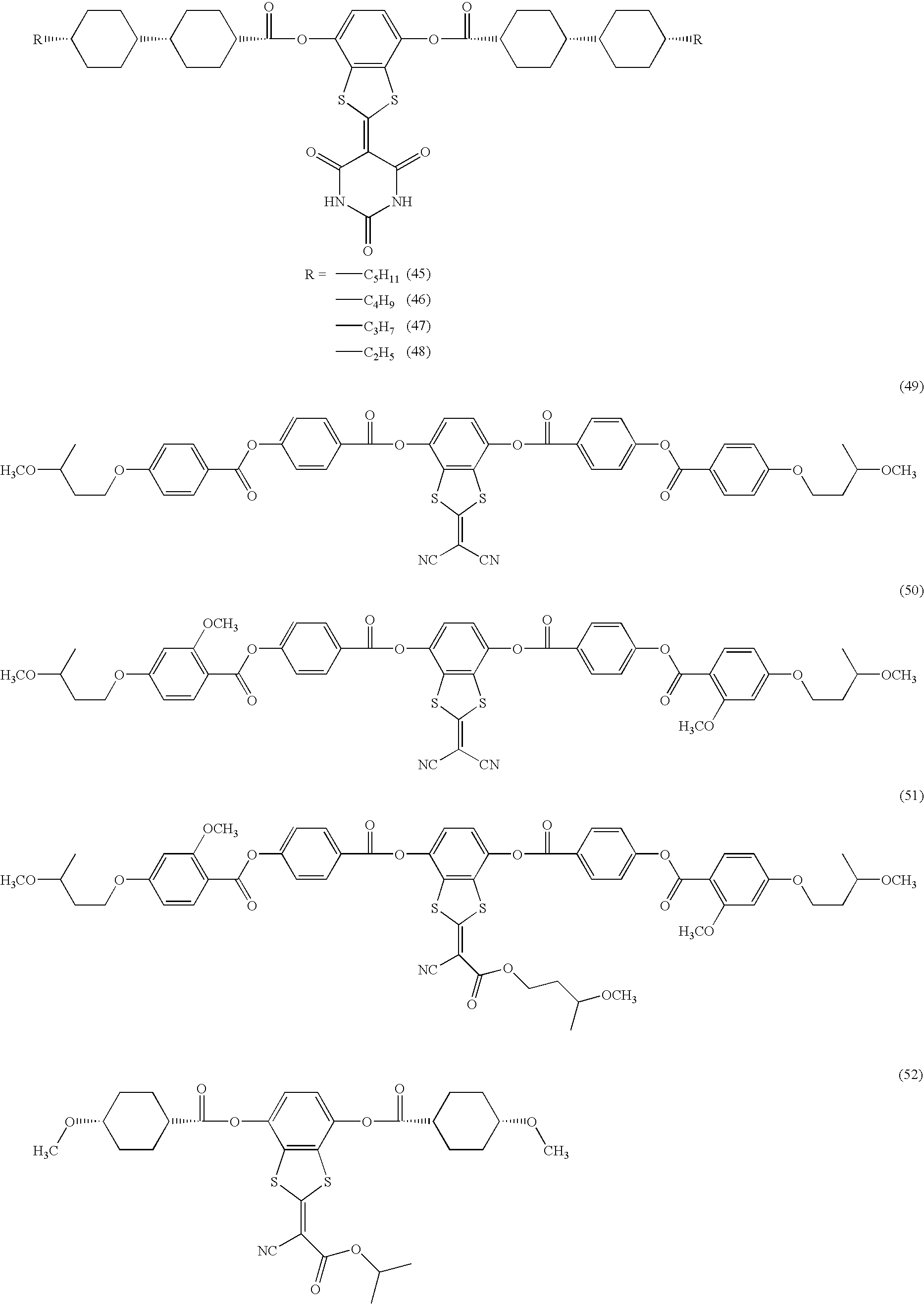

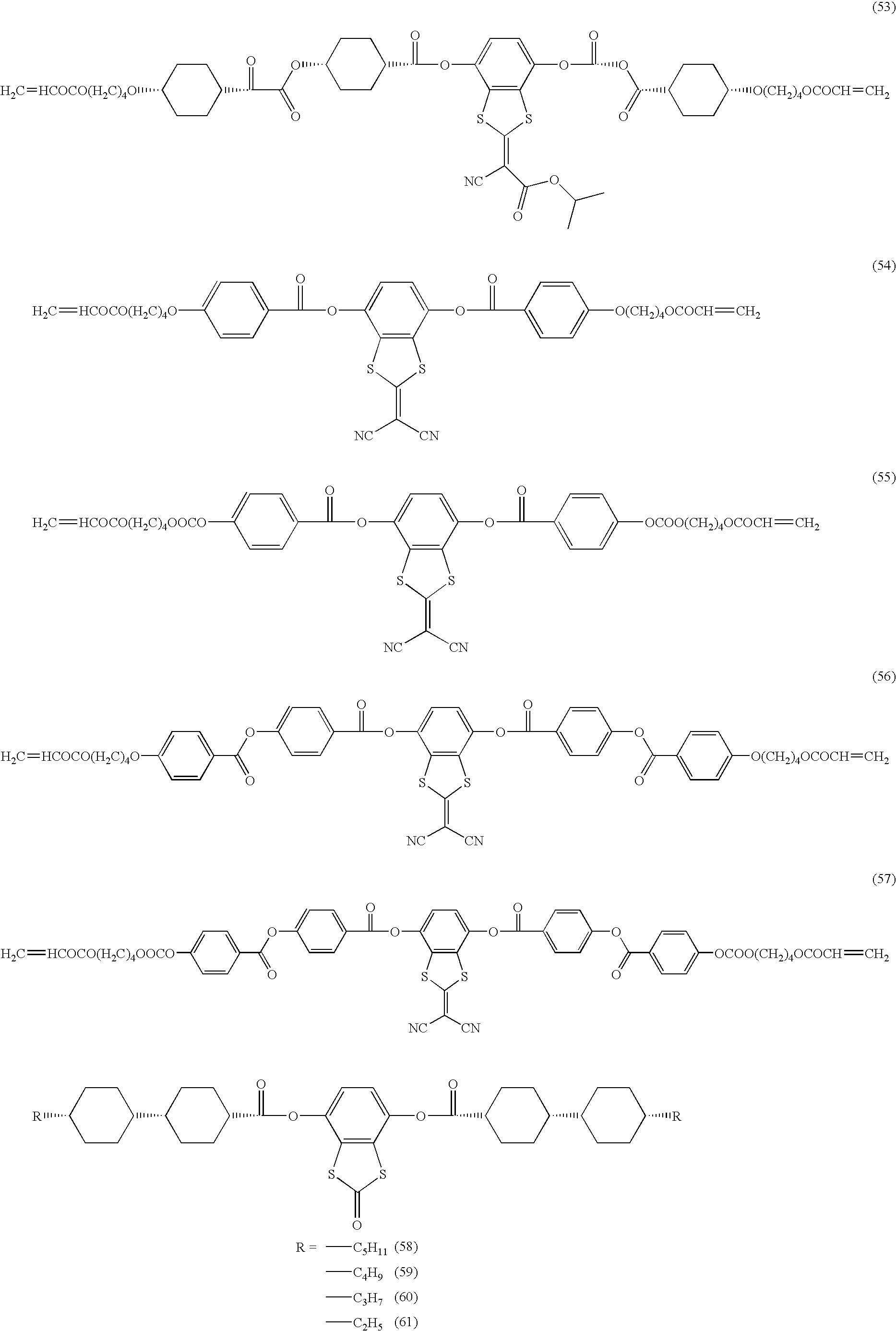

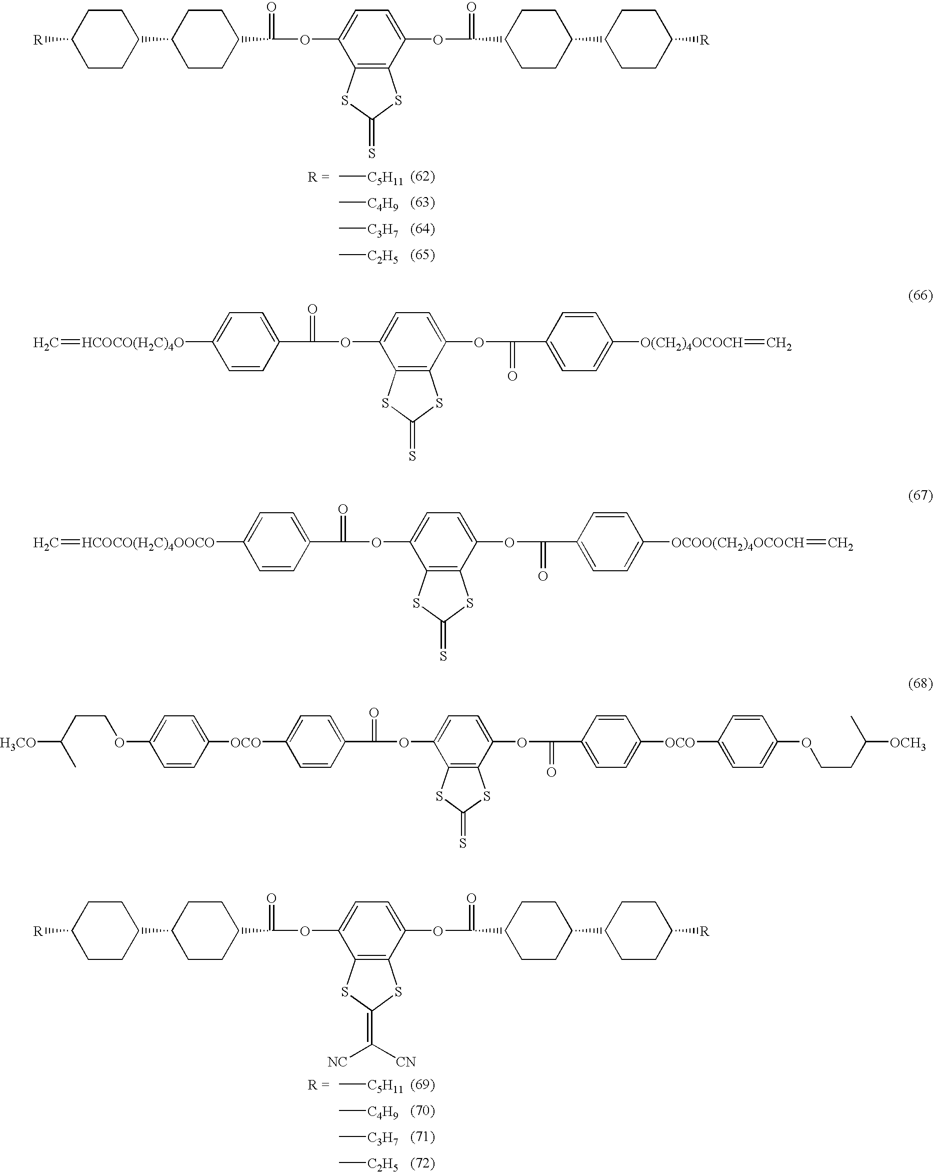

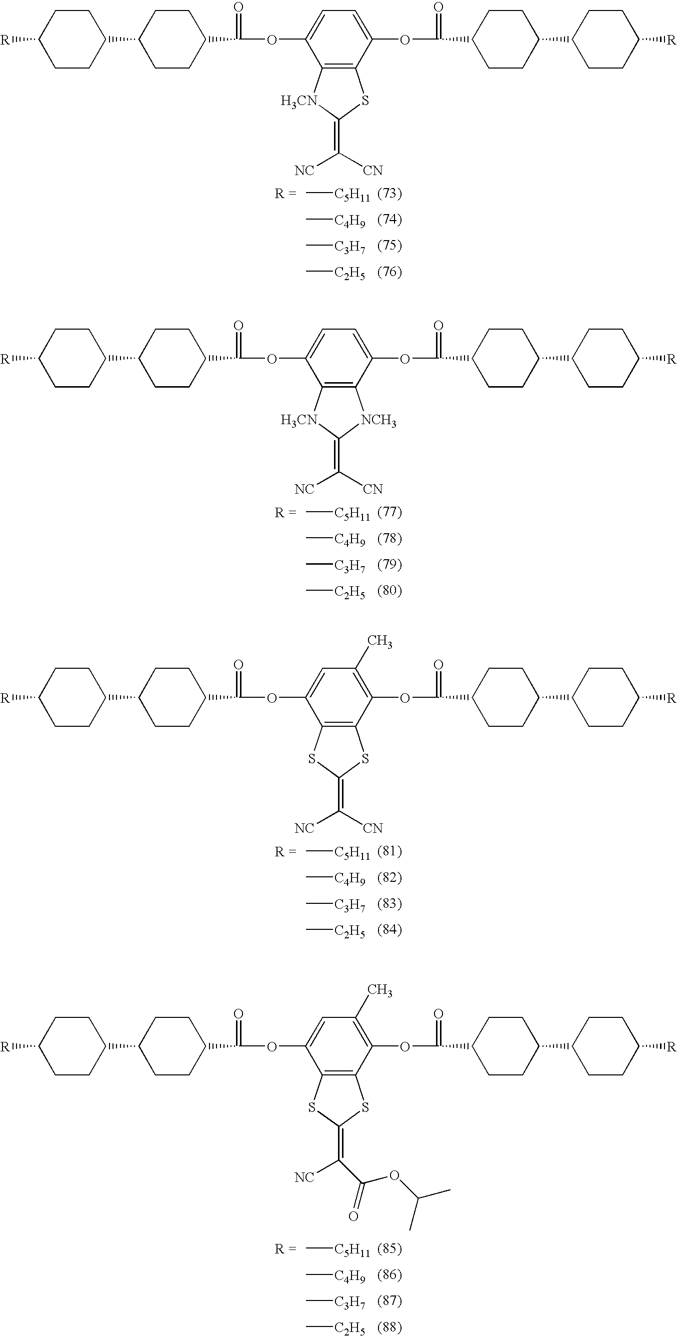

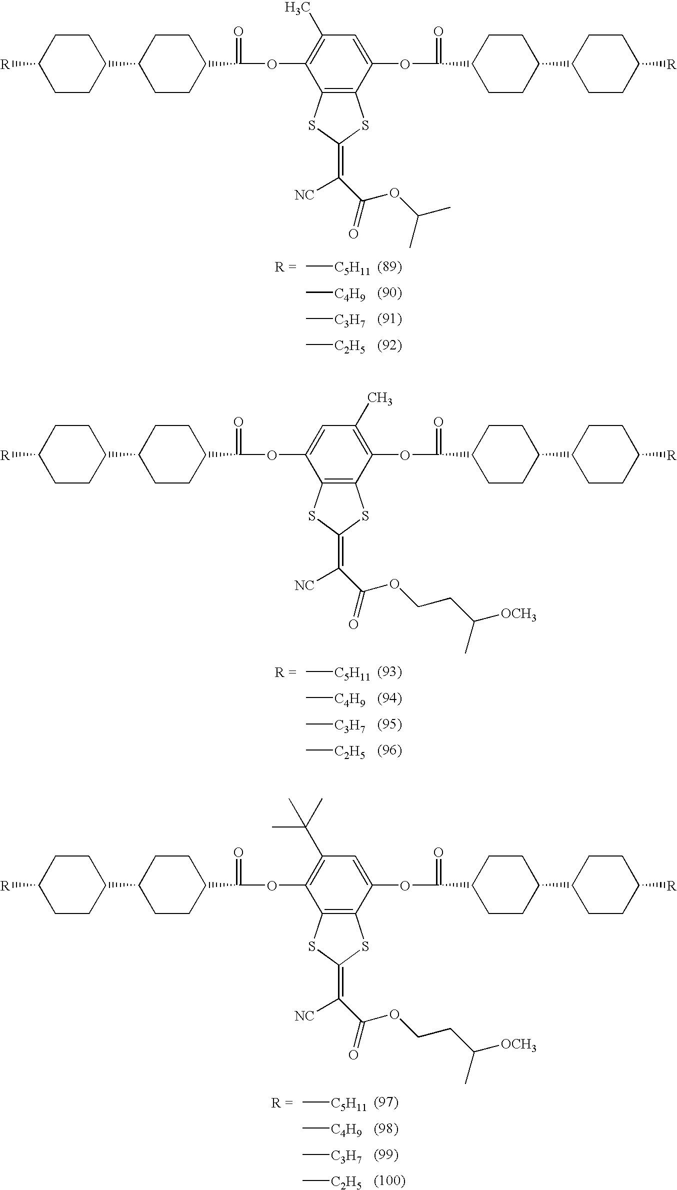

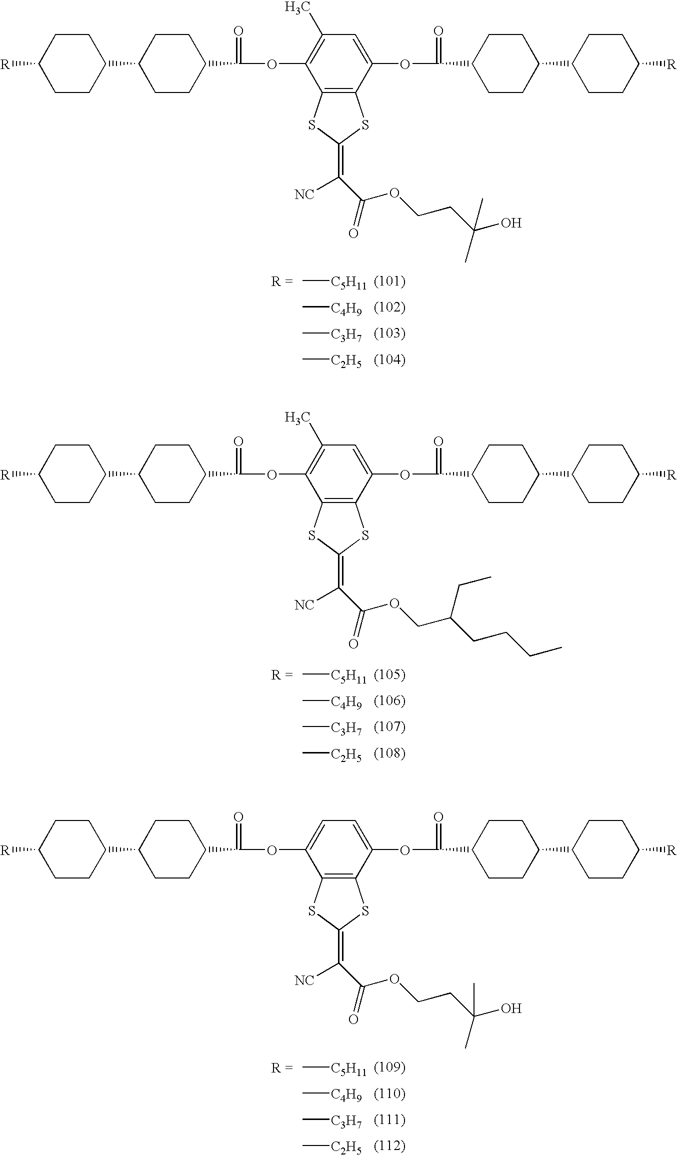

The compound represented by the formula (A) or (B) may be synthesized referring to known methods. For example, Compound (1) may be synthesized according to the following scheme.

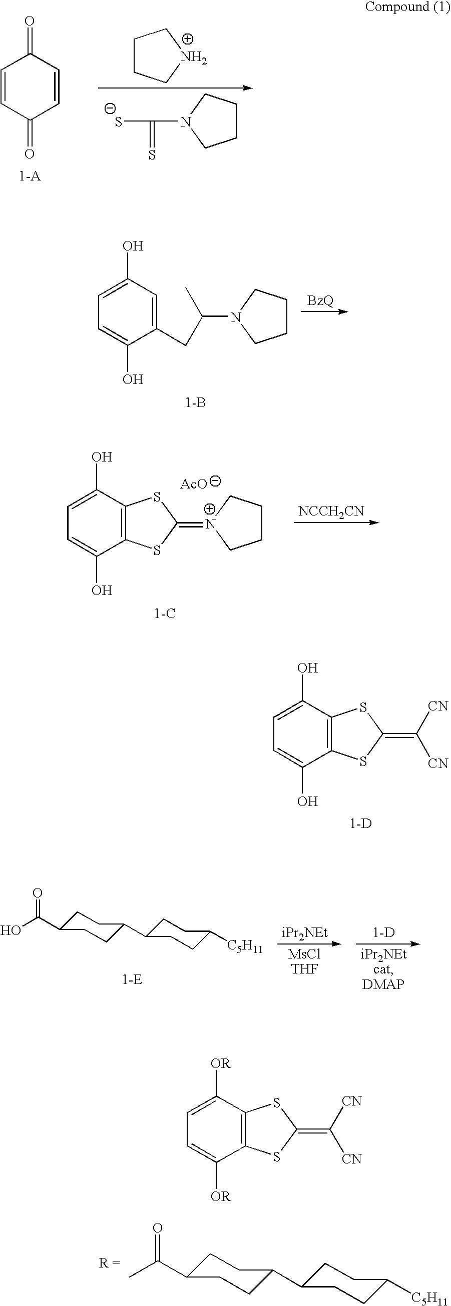

In the above scheme, the steps for producing Compound (1-d) from Compound (1-A) may be carried out referring to the description in “Journal of Chemical Crystallography” (1997); 27(9); p. 515-526.

As shown in the above scheme, Compound (1) may be produced as follows. A tetrahydrofuran solution of Compound (1-E) is added with methanesulfonic acid chloride, added dropewise with N,N-di-iso-propylethylamine and then stirred. After that, the reaction solution is added with N,N-di-iso-propylethylamine, added dropewise with a tetrahydrofuran of Compound (1-D), and then added dropewise with a tetrahydrofuran solution of N,N-dimethylamino pyridine (DMAP).

Examples of the material having regular wavelength dispersion characteristics include rod-like compounds represented by formula (a) below. The material is preferably selected from the compounds showing liquid crystallinity. Such a rod-like compound may be aligned along with polymer material such as cellulose acylate and may contribute to developing retardation, and in another aspect, such a rod-like compound may contribute to improving dissolubility.

Ar¹−L¹²−X−L¹³−Ar² Formula (a):

In formula (a), Ar¹ and Ar² independently represent an aromatic group; L¹² and L¹³ independently represent —O—CO— or —CO—O—; X represents 1,4-cyclohexylen, vinylene or ethynylene.

In the description, the term “aromatic group” is used for any substituted or non-substituted aryl (aromatic hydrocarbon) group and any substituted or non-substituted aromatic heterocyclic group.

Substituted or non-substituted aryl groups are preferred to substituted or non-substituted aromatic heterocyclic group. A hetero ring in the aromatic heterocyclic group is generally unsaturated. Preferably, the aromatic hetero ring is selected from 5-, 6- and 7-membered rings; and more preferably 5- and 6-membered rings. An aromatic hetero ring generally has the maximum number of double bonds. Preferred examples of the hetero atom embedded in the hetero ring include nitrogen, oxygen and sulfur atoms; and more preferred examples include nitrogen and sulfur atoms.

Examples of the aromatic ring in the aromatic group include benzene, furan, thiophene, pyrrole, oxazole, thiazole, imidazole, triazole, pyridine, pyrimidine and pyrazine rings; and among these, a benzene ring is especially preferred.

Examples of the substituent, that the substituted aryl group and the substituted aromatic heterocyclic group have, include halogen atoms (e.g., F, Cl, Br, and I), hydroxyl, carboxyl, cyano, amino, alkylaminos (e.g., methylamino, ethylamino, butylamino and dimethylamino), nitro, sulfo, carbamoyl, alkylcarbamoyls (erg., N-methylcarbamoyl, N-ethylcarbamoyl, and N,N-dimethylcarbamoyl), sulfamoyl, alkylsulfamoyls (e.g., N-methylsulfamoyl, N-ethylsulfamoyl, and N,N-dimethylsulfamyl), ureido, alkylureidos (e.g., N-methylureido, N,N-dimethylureido, and N,N,N′-trimethyl ureido), alkyls (e.g., methyl, ethyl, propyl, butyl, pentyl, heptyl, octyl, isopropyl, s-butyl, t-amyl, cyclohexy, and cyclopentyl), alkenyls (e.g., vinyl, allyl, and hexenyl), alkynyls (e.g., ethynyl and butynyl), acyls (e.g., formyl, acetyl, butyryl, hexanoyl and lauryl), acyloxys (e.g., acetoxy, butyryloxy, hexanoyloxy, and lauryloxy), alkoxys (e.g., methoxy, ethoxy, propoxy, butoxy, pentyloxy, heptyloxy, and octyloxy), aryloxys (e.g., phenoxy), alkoxycarbonyls (e.g., methoxycarbonyl, ethoxycarbonyl, propoxycarbonyl, butoxycarbonyl, pentyloxycarbonyl, and heptyloxycarbonyl), aryloxycarbonyls (e.g., phenoxycarbonyl), alkoxycarbonylaminos (e.g., butoxycarbonylamino, and hexylcarbonylamino), alkylthios (e.g., methylthio, ethylthio, propylthio, butylthio, pentylthio, heptylthio and octylthio), arylthios (e.g., phenylthio), alkylsulfonyl (e.g., methylsulfonyl, ethylsulfonyl, propylsulfonyl, butylsulfonyl, pentylsulfonyl, heptylsulfonyl, and octylsulfonyl), amidos (e.g., acetamido, butylamido, hexylamido, and laurylamido), and non-aromatic hetero ring residues (e.g., morpholino, and pyridyl).

Among these, halogen atoms, cyano, carboxyl, hydroxyl, amino, alkyl-substituted aminos, acyls, acyloxys, amidos, alkoxycarbonyls, alkoxys, alkylthios and alkyls are preferred.

The alkyl moiety in the alkyl amino, alkoxycarbonyl, alkoxy or alkylthio may have at least one substituent. Examples of the substituent in the alkyl moieties or in the alkyls include halogen atoms, hydroxyl, carboxyl, cyano, amino, alkylaminos, nitro, sulfo, carbamoyl, alkylcarbamoyls, sulfamoyl, alkylsulfamoyls, ureido, alkylureidos, alkenyls, alkynyls, acyls, acyloxys, acylaminos, alkoxys, aryloxys, alkoxycarbonyls, aryloxycarbonyls, alkoxycarbonylaminos, alkylthios, arylthios, alkylsulfonyls, amidos and non-aromatic hetero ring residues. Among these, halogen atoms, hydroxyl, amino, alkylaminos, acyl, acyloxys, acylaminos, alkoxycarbonyls and alkoxys are preferred.

In formula (a), L¹² and L¹³ independently represent —O—CO— or —CO—O—.

In formula (a), X represents 1,4-cyclohexylen, vinylene or ethynylene.

Examples of the compound represented by formula (a) include, but are not limited to, those shown below.

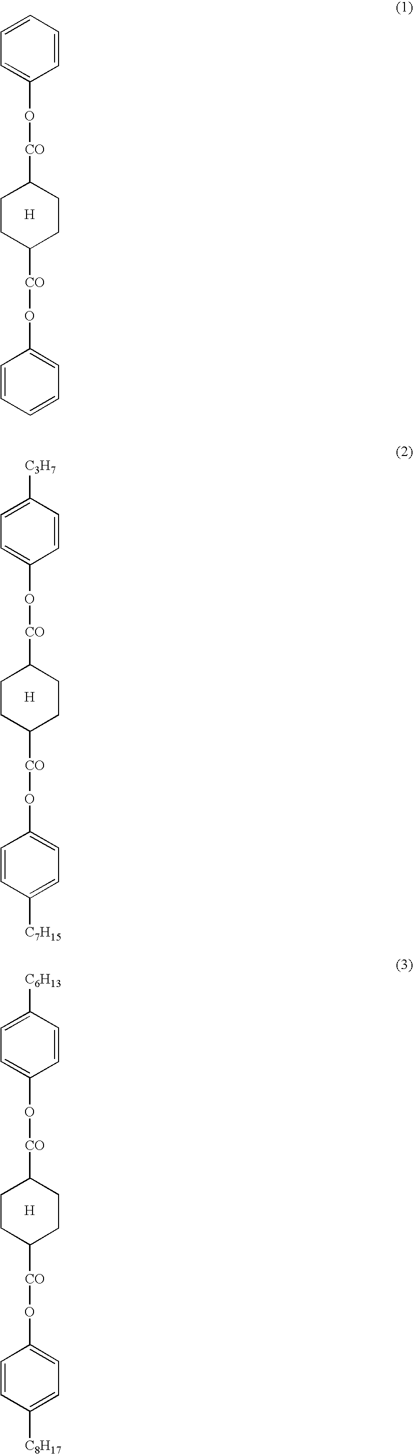

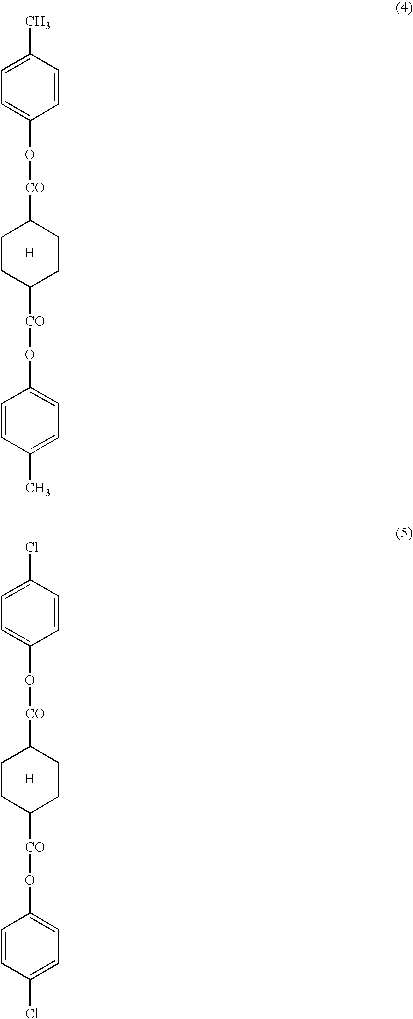

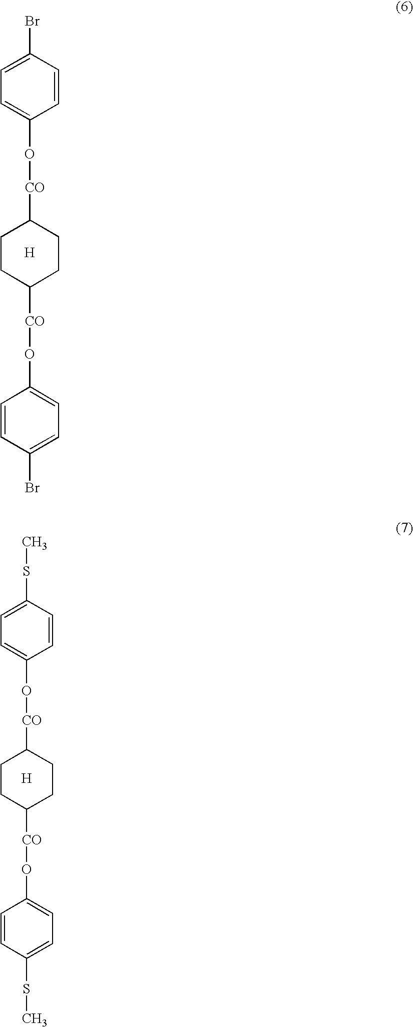

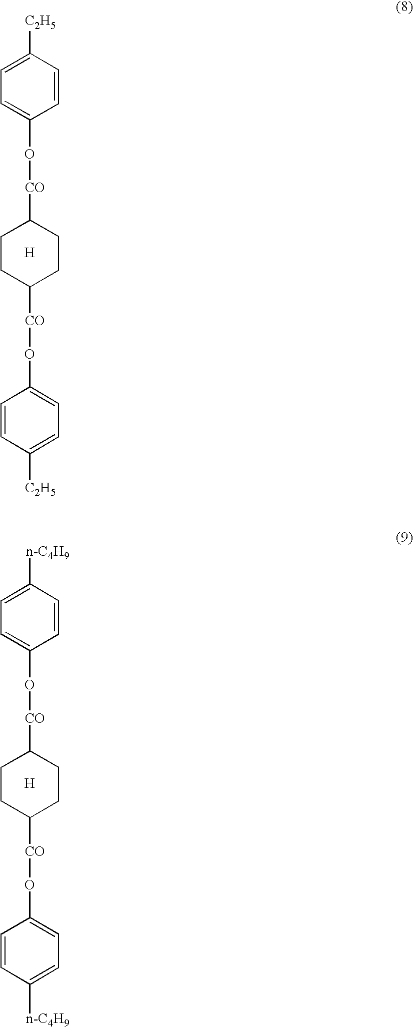

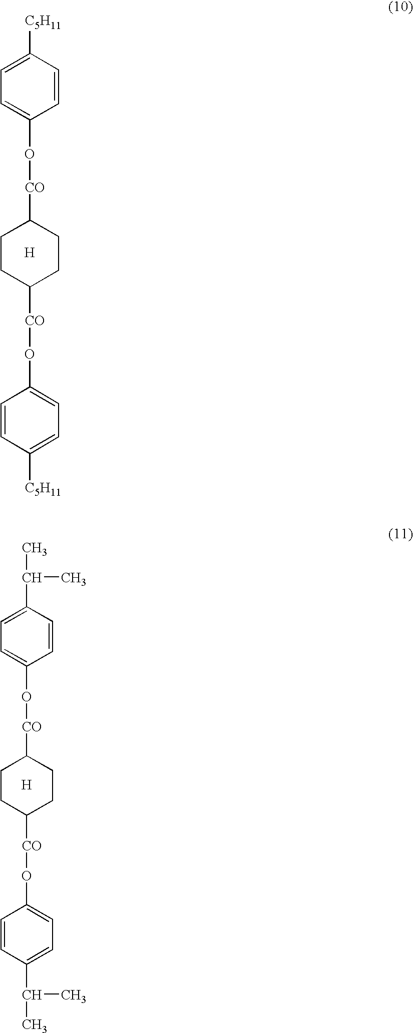

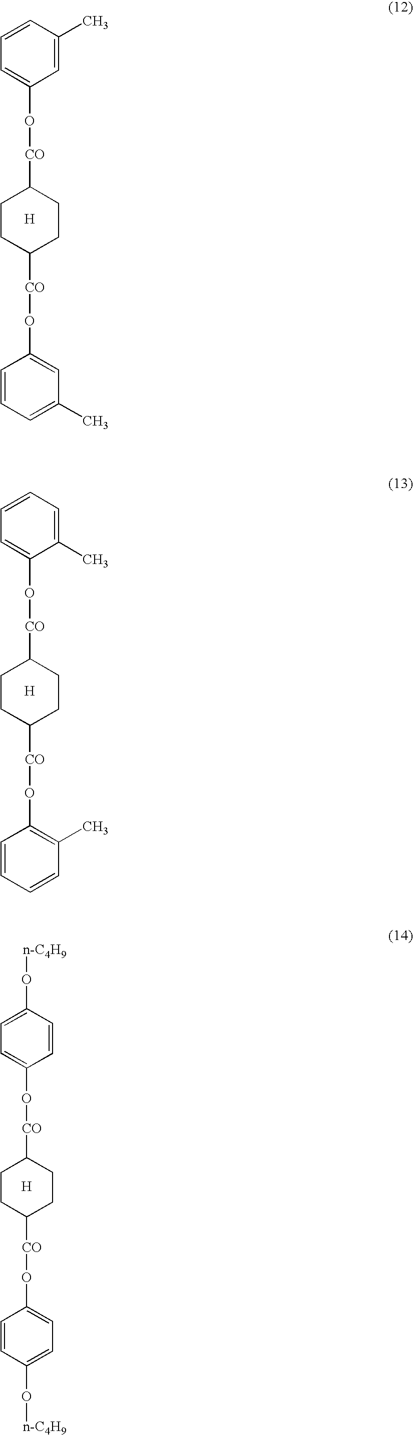

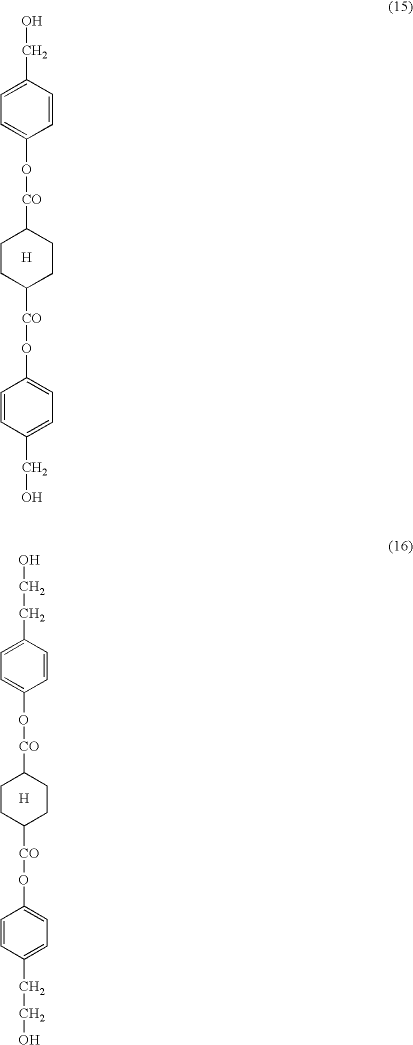

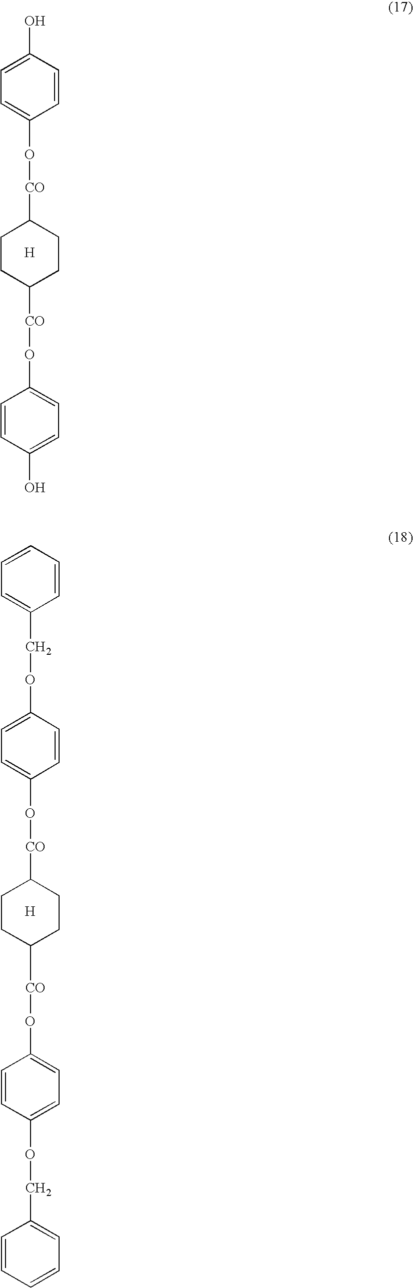

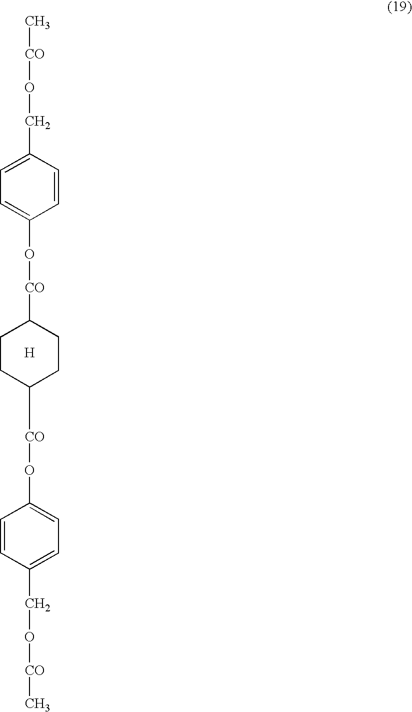

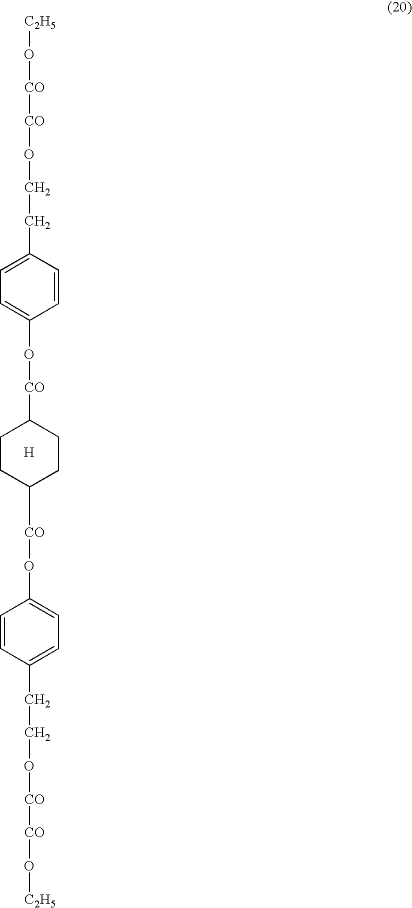

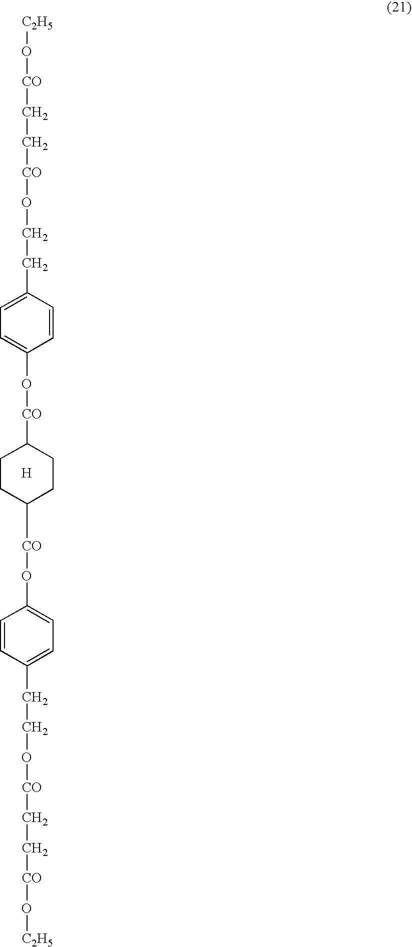

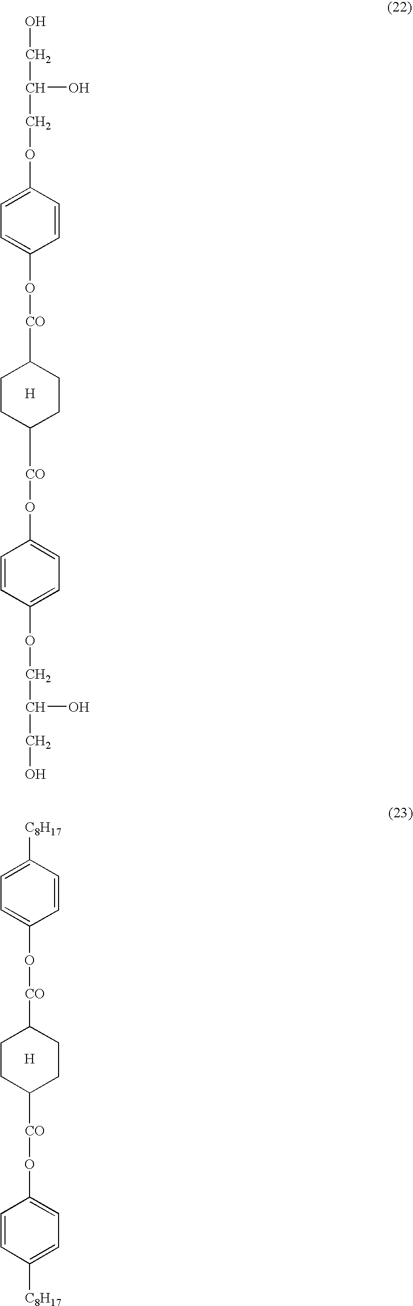

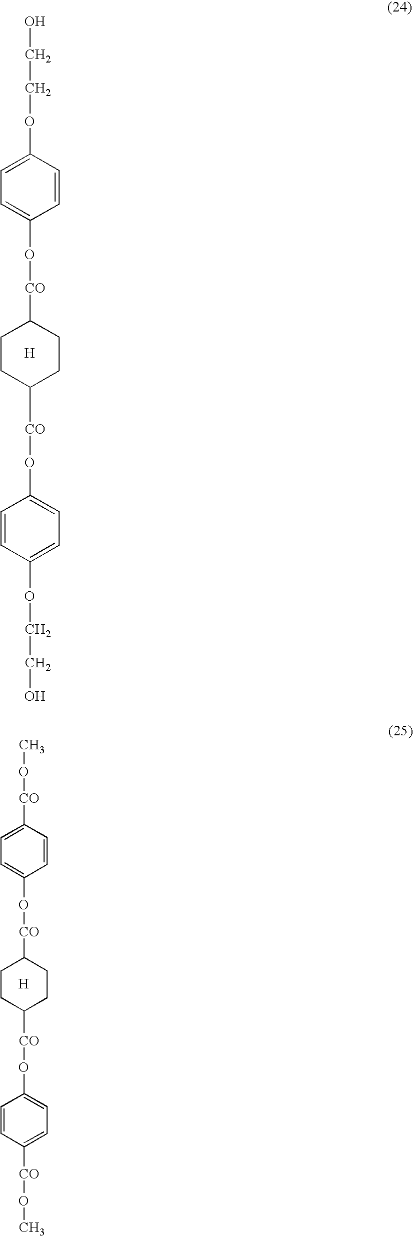

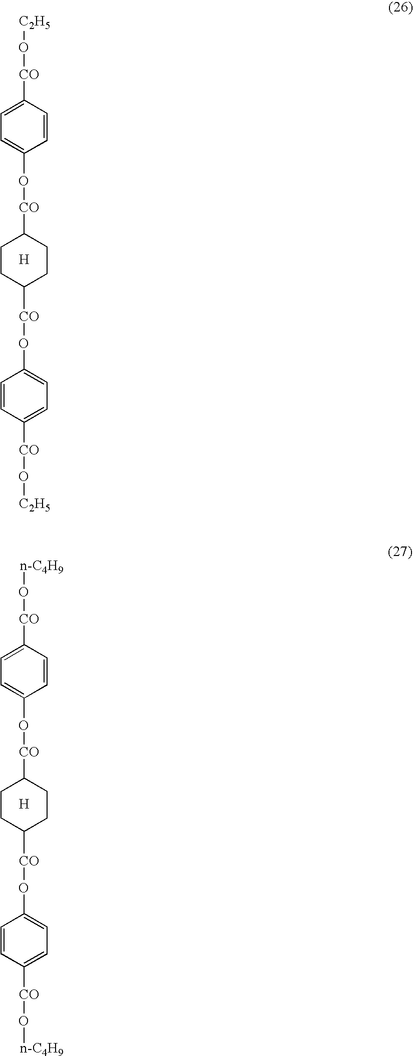

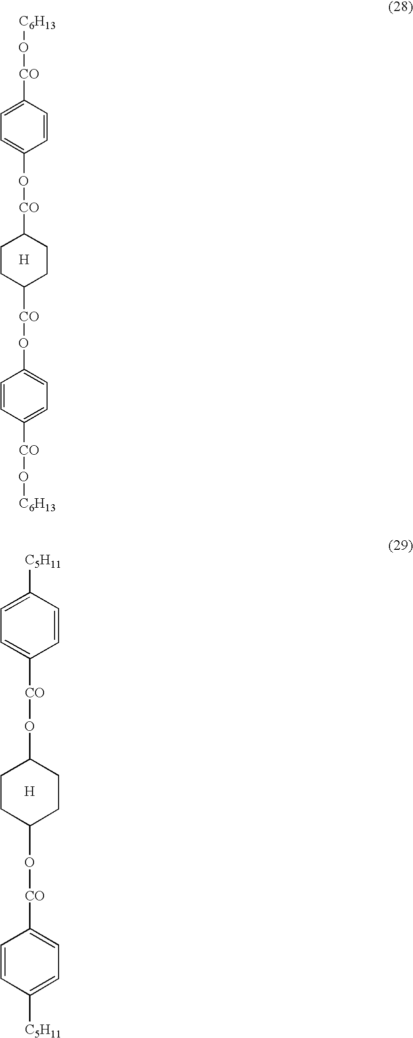

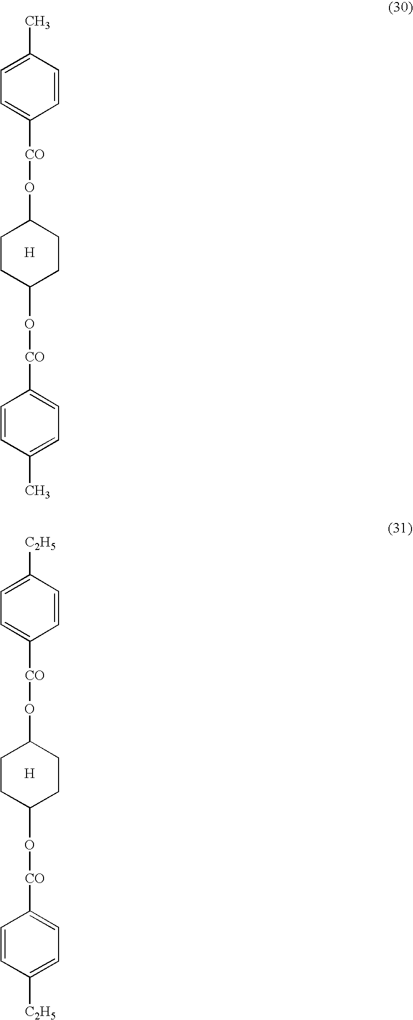

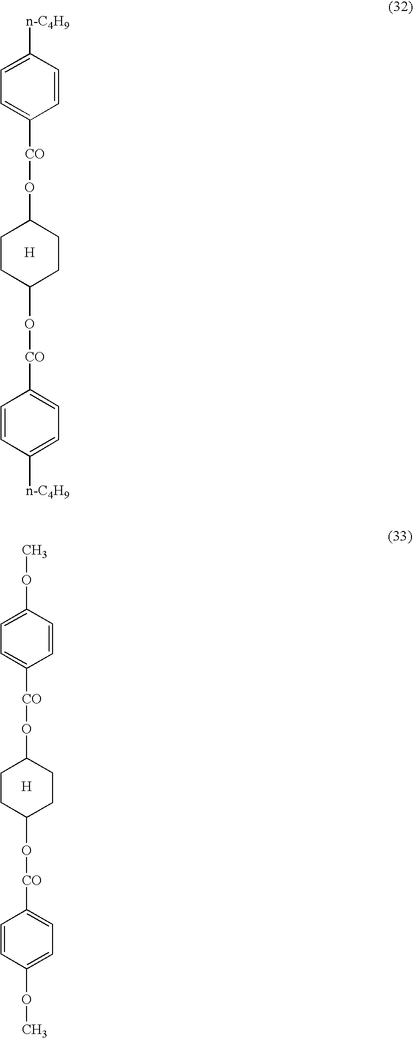

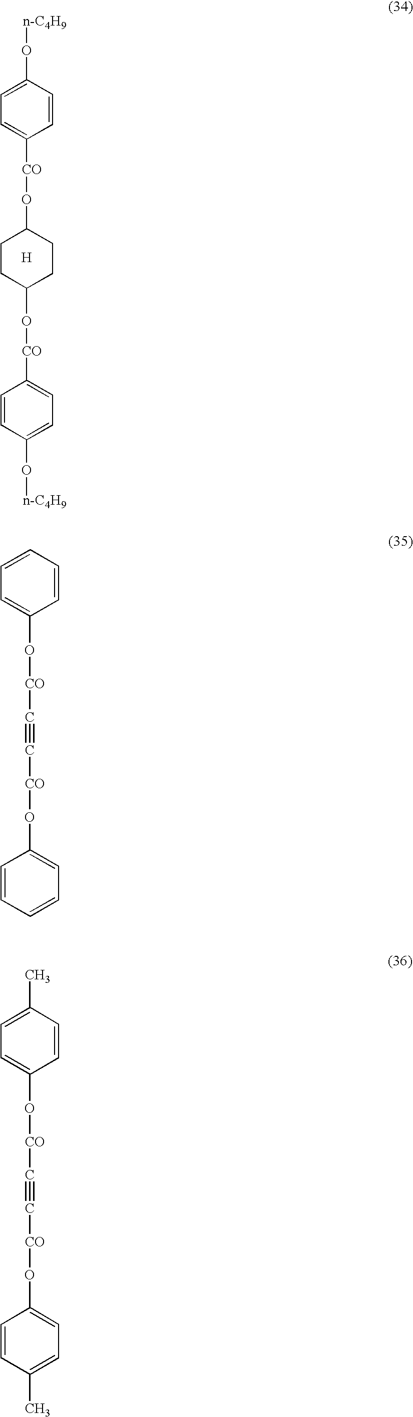

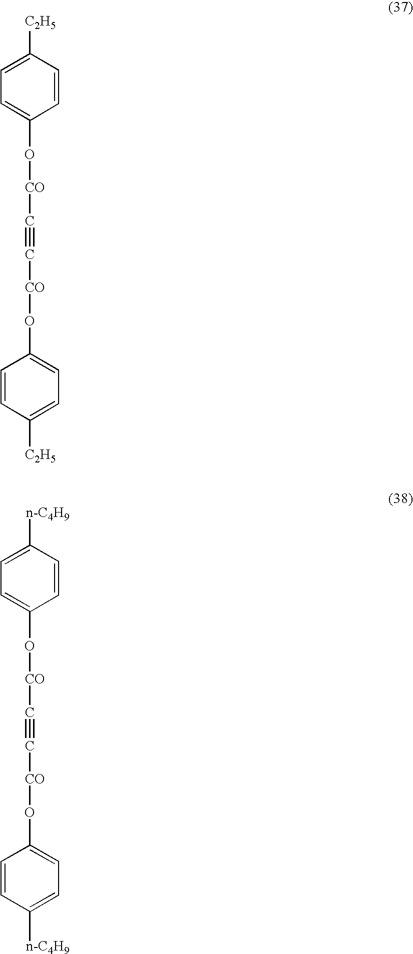

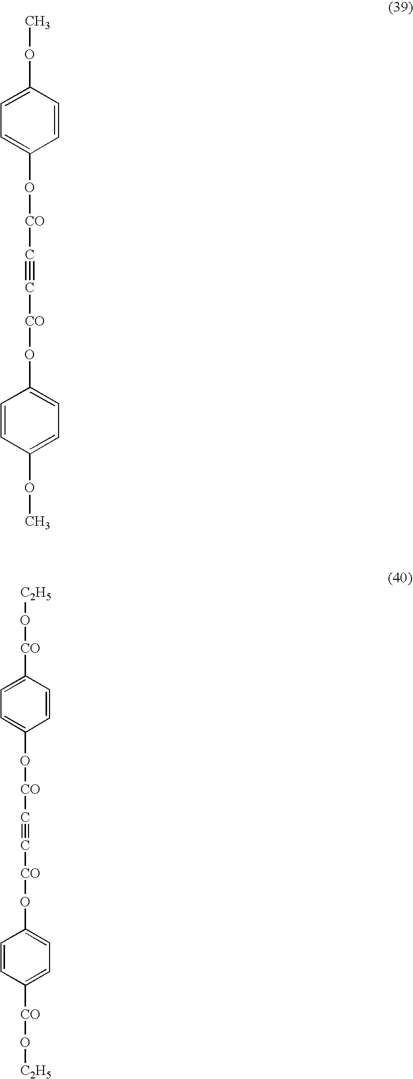

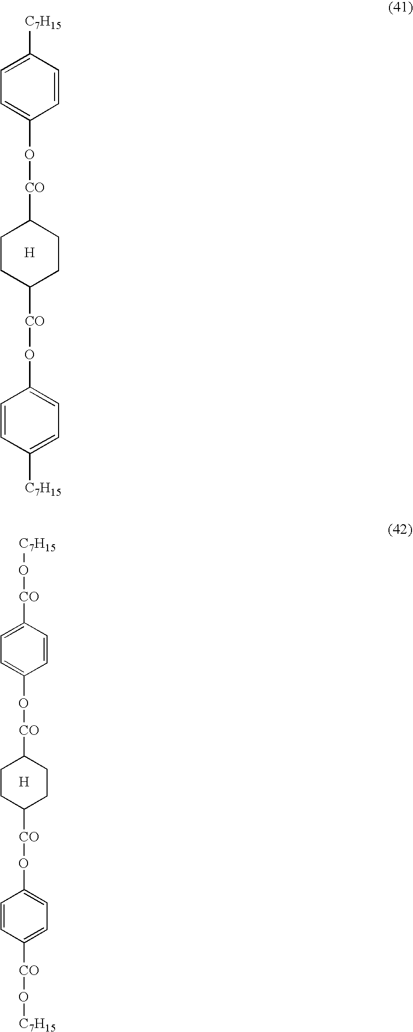

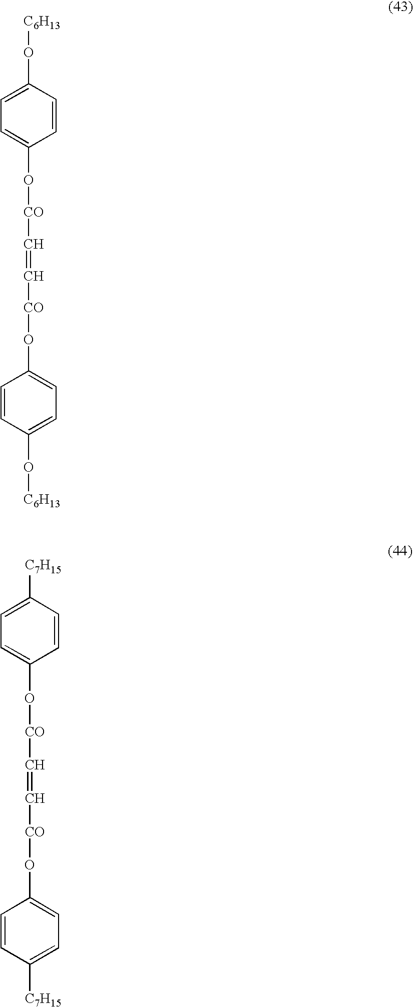

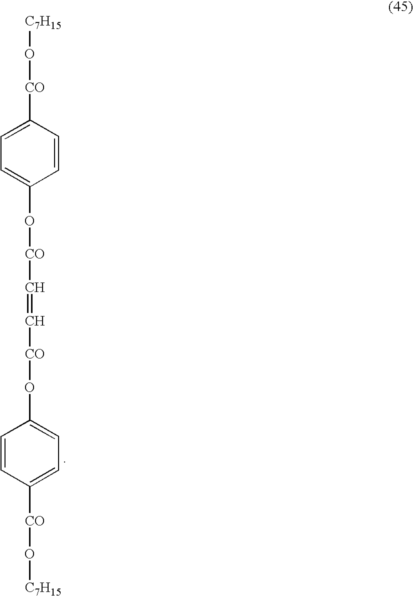

The example compounds (1) to (34), (41) and (42) have two asymmetric carbon atoms in the 1- and 4-positions in the cyclohexane ring, however it is noted that their molecular structures are meso-type structures and symmetric. Therefore, there is no enantiomer thereof, and are only geometric isomers, trans and cis types thereof. Of the example compound (1), the trans (1-trans) and cis (1-cis) types are shown below.

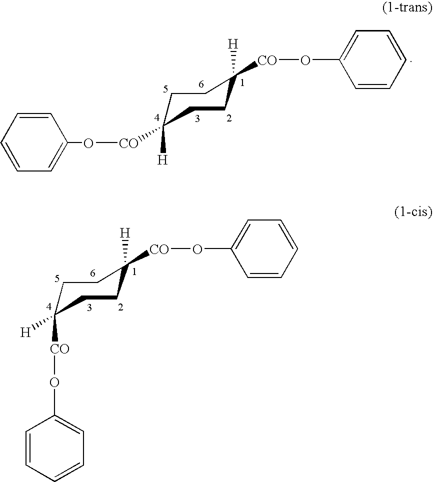

Preferably, the molecular structures of the rod-like compounds are linear.

Therefore, trans types are preferred to cis types.

Addition to the geometric isomers, there are enantiomers of the example compound (2) and (3), and the total number of the isomers is four. Among the geometric isomers, trans types are preferred to the cis types. And among the enantiomers, they are nearly equal, and D-, L- and racemic bodies are used equally.

There are trans and cis types as a center of the vinylene bond of the example compounds (43) to (45). On the same reason as above, the trans types are preferred to the cis types.

Examples of the material having regular wavelength dispersion characteristics also include compounds represented by formula (I).

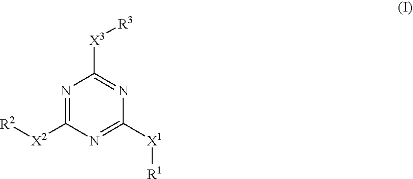

In the formula, X¹ represents a single bond, —NR⁴—, —O— or —S—; X² represents a single bond, —NR⁵—, —O— or —S—; X³ represents a single bond, —NR⁶—, —O— or —S—. And, R¹, R², and R³ independently represent an alkyl group, an alkenyl group, an aromatic ring group or a hetero-ring residue; R⁴, R⁵ and R⁶ independently represent a hydrogen atom, an alkyl group, an alkenyl group, an aryl group or a hetero-ring group.

Preferred examples, I-(1) to IV-(10), of the compound represented by the formula (I) include, but are not limited to, those shown below.

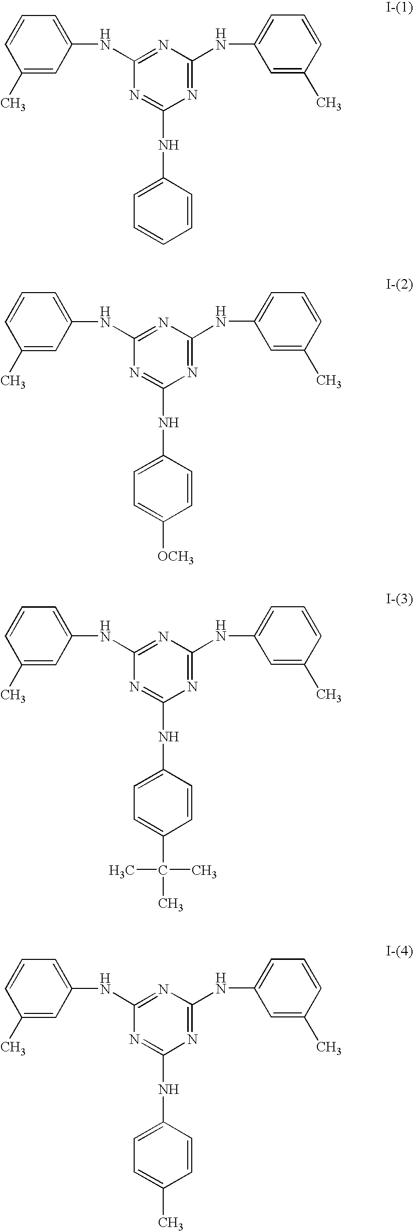

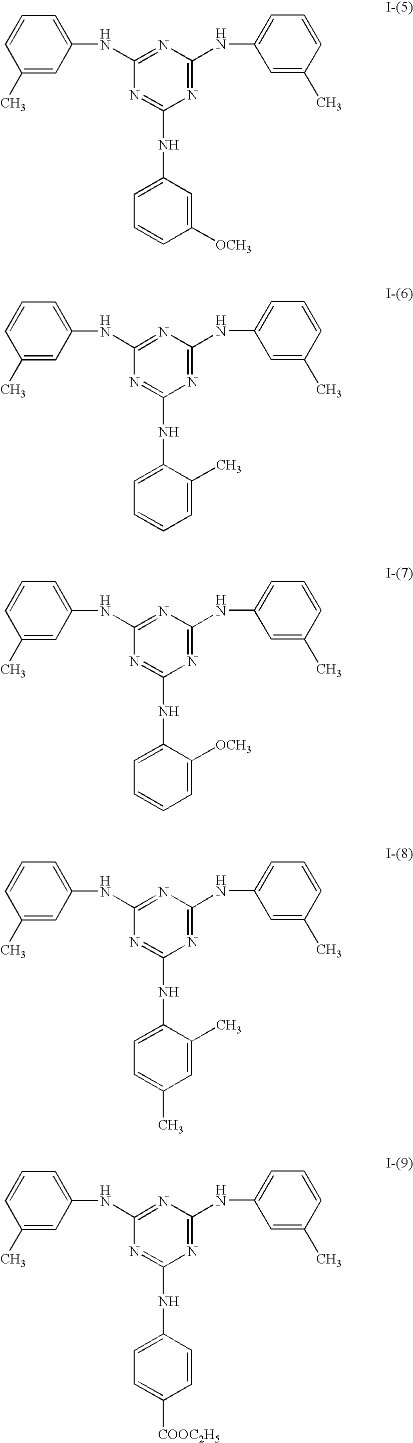

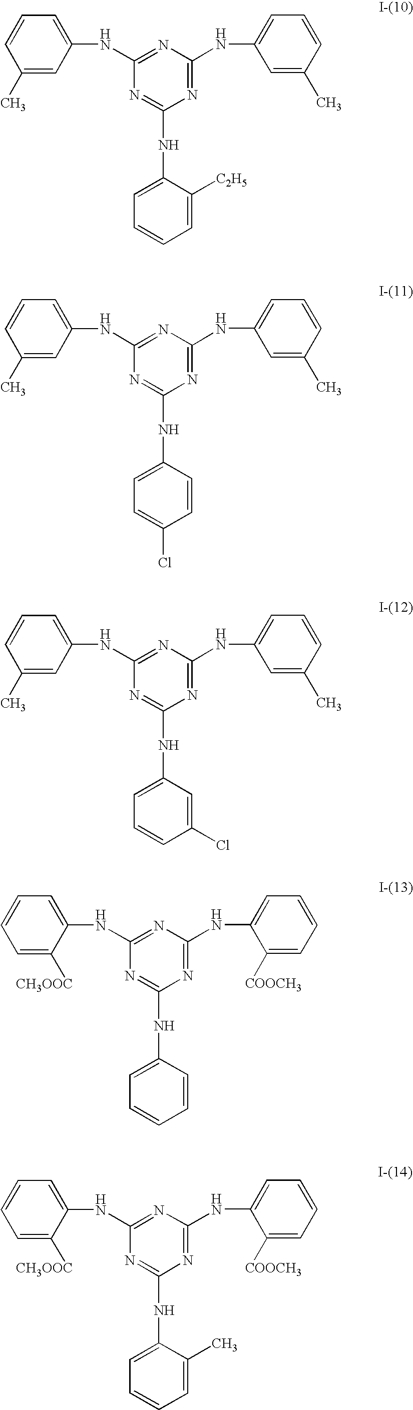

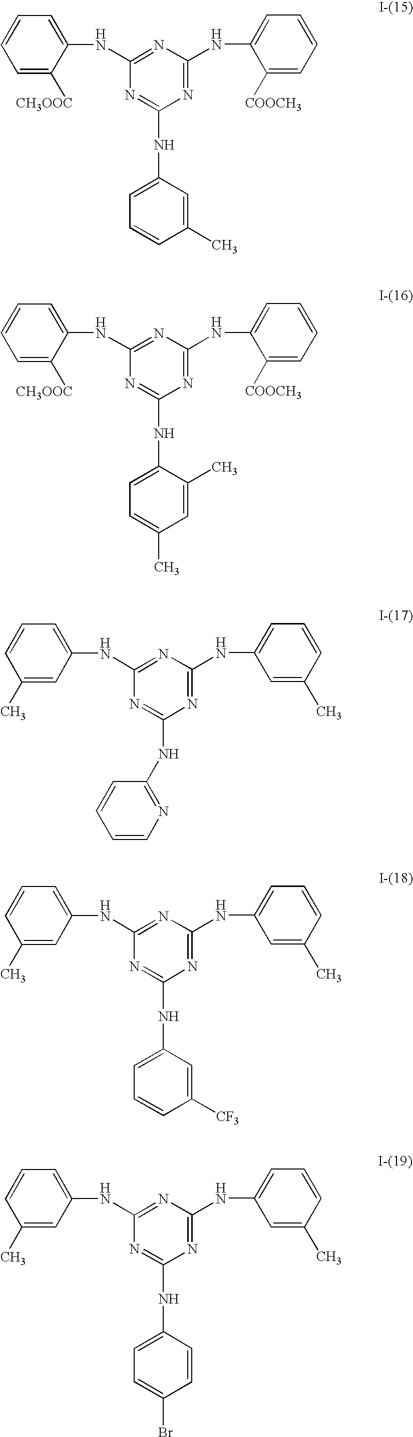

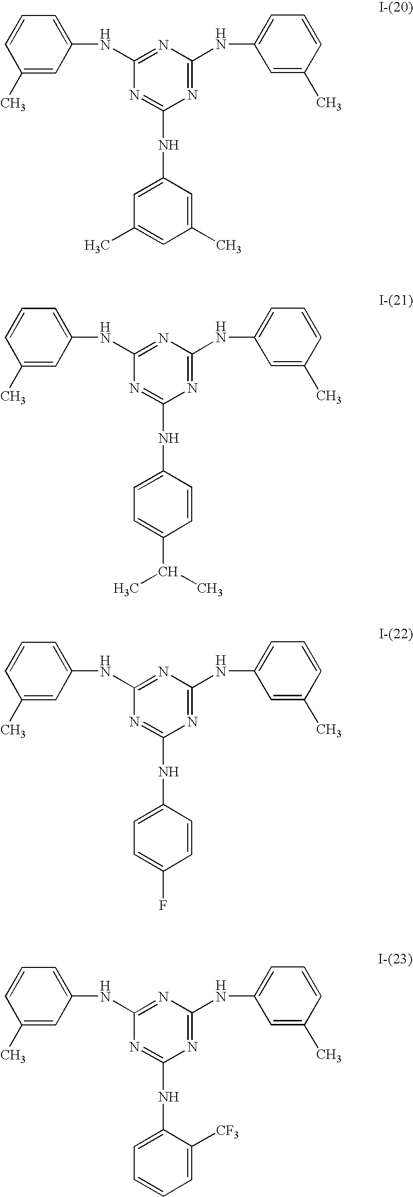

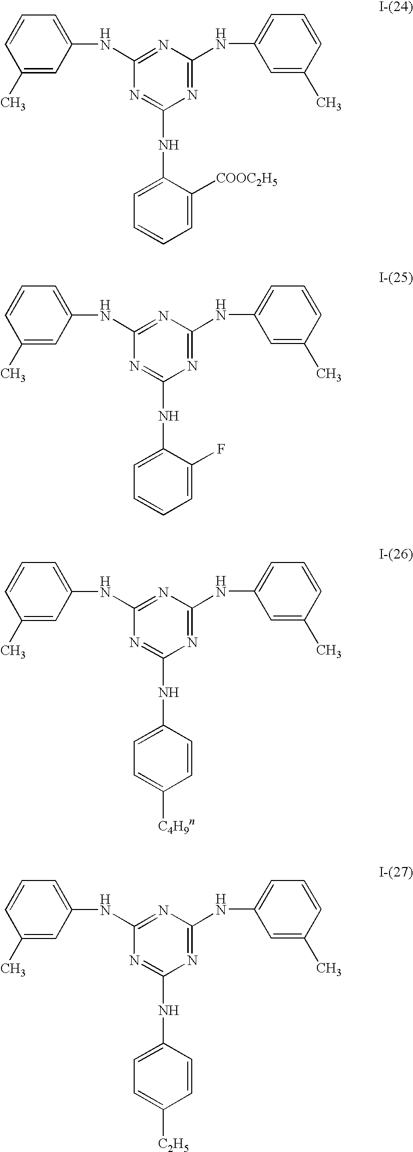

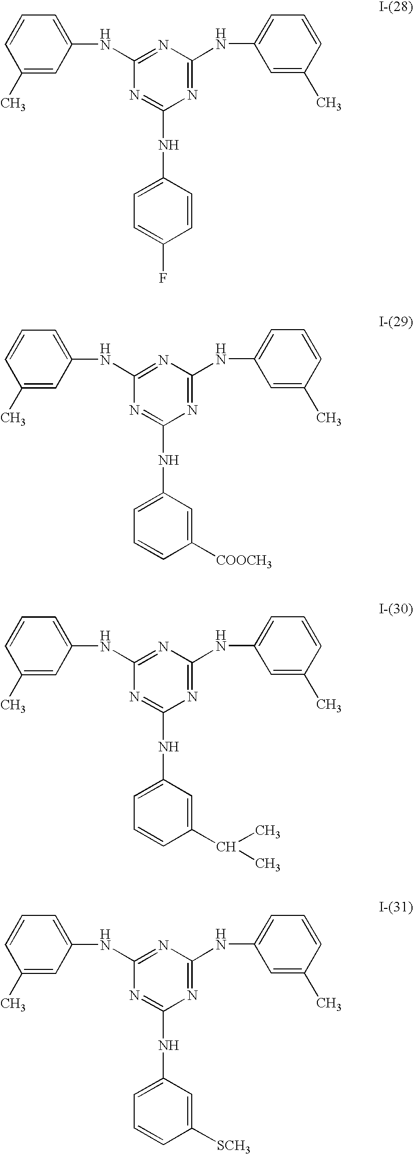

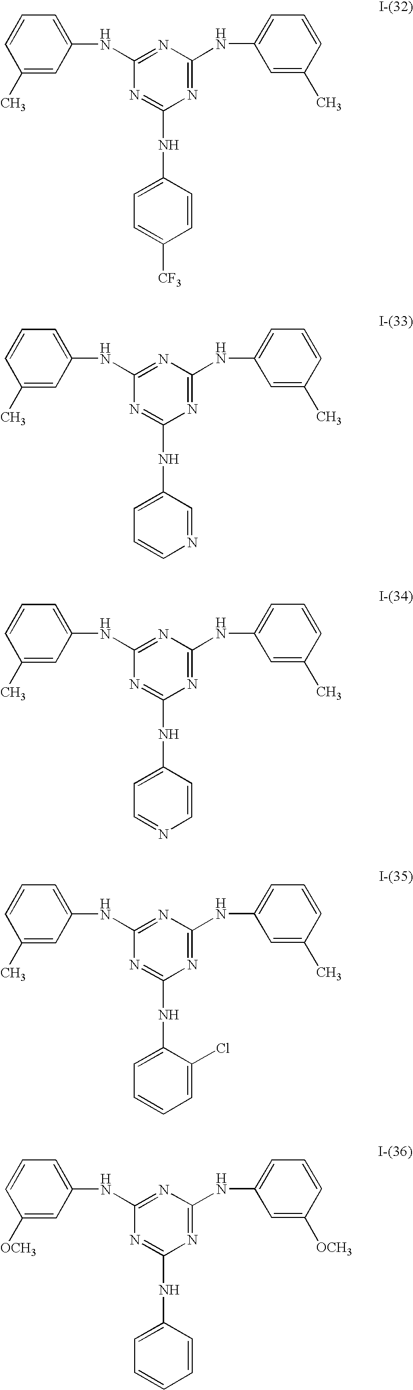

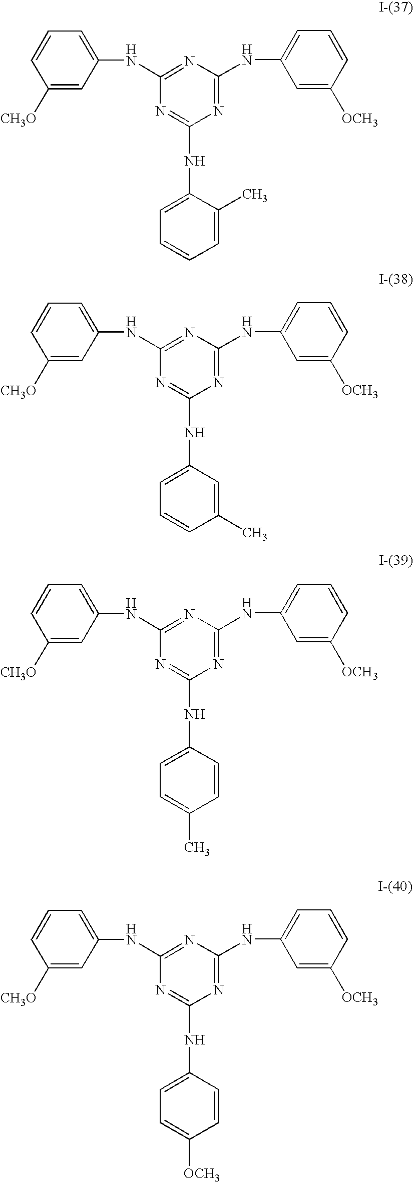

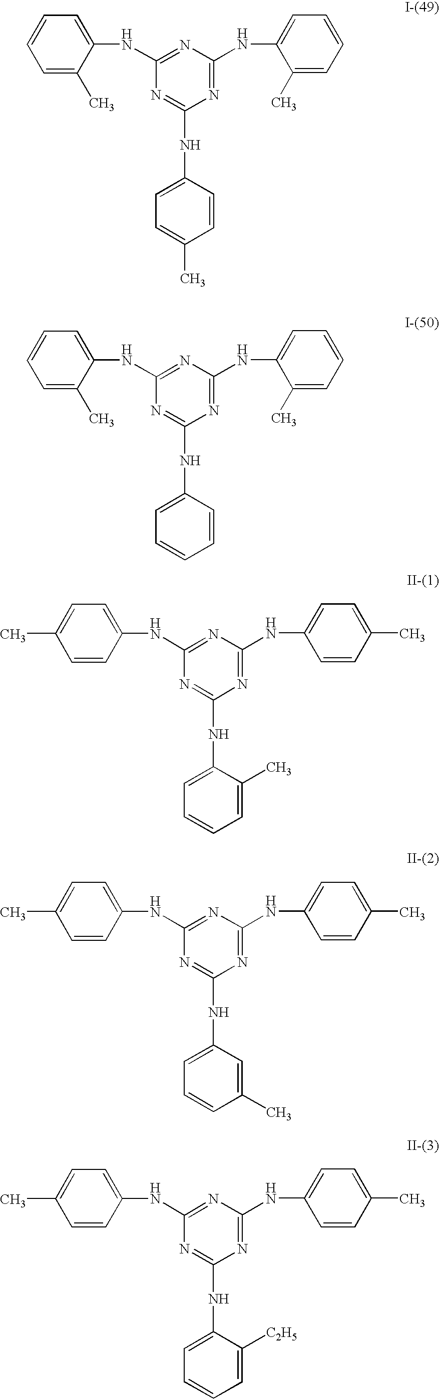

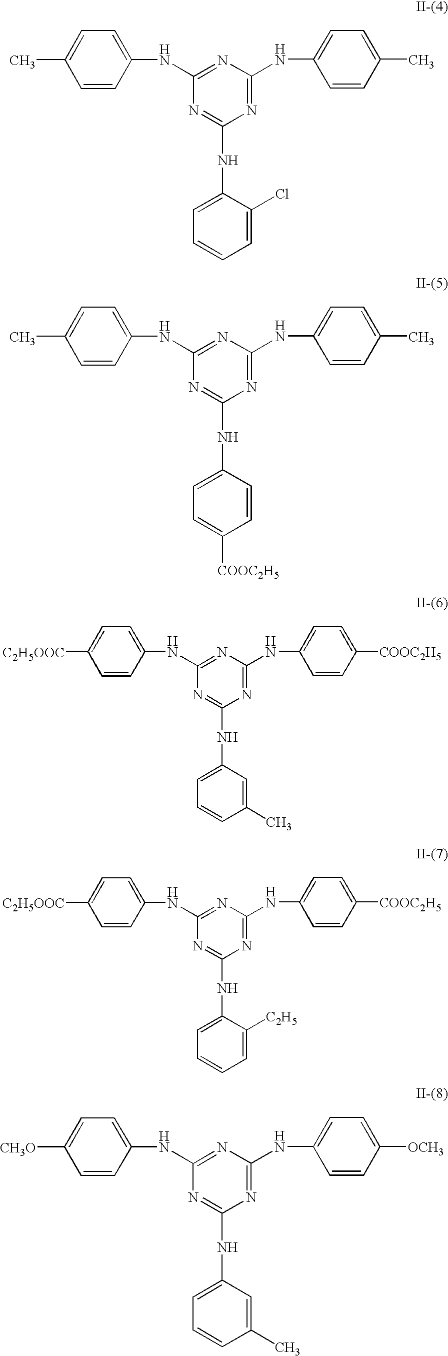

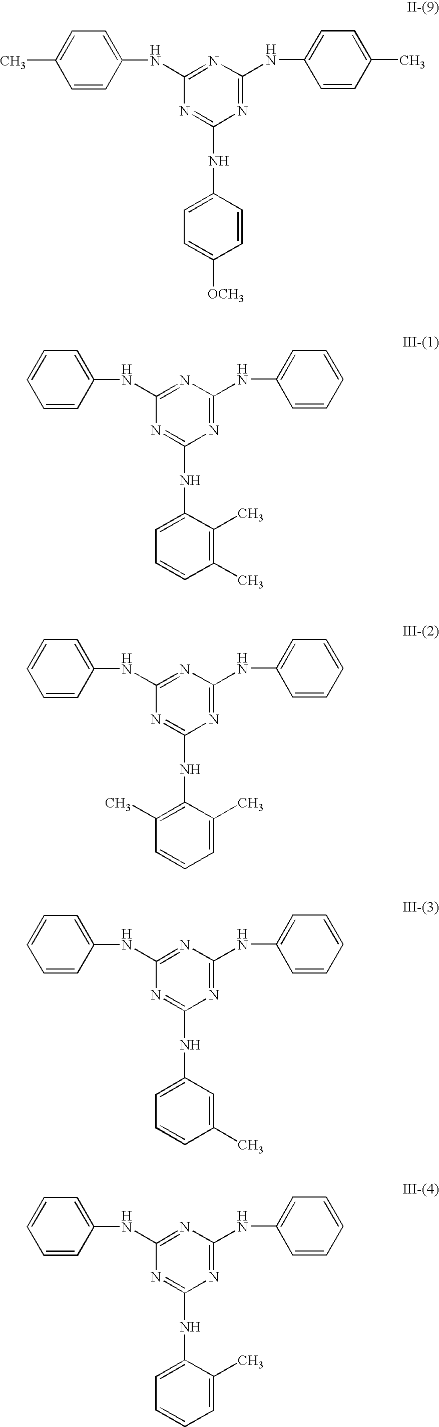

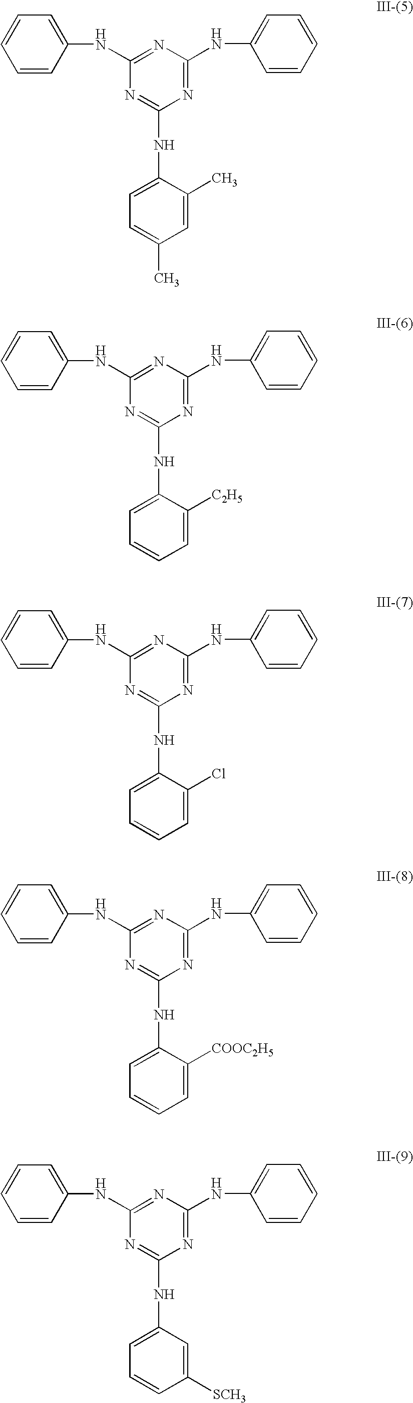

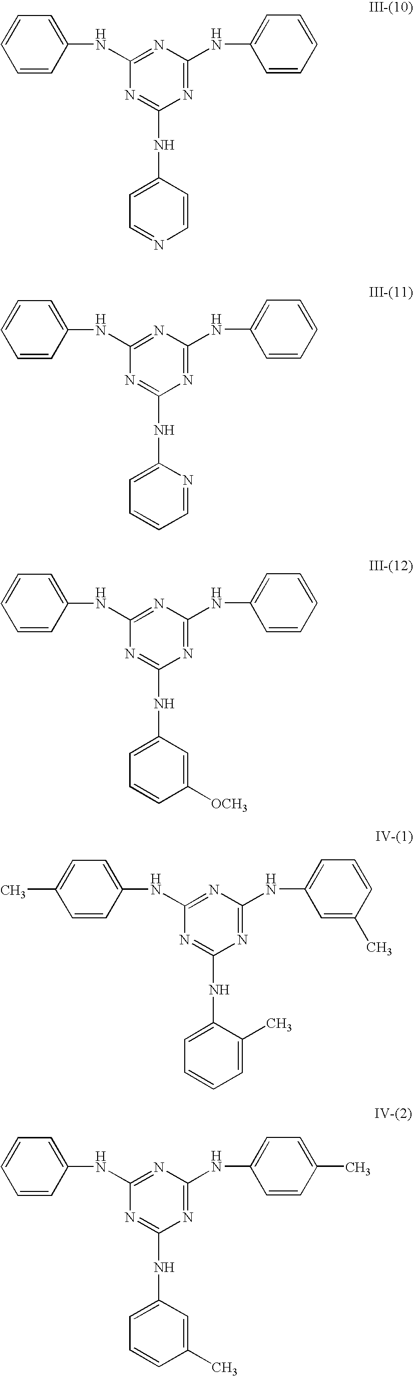

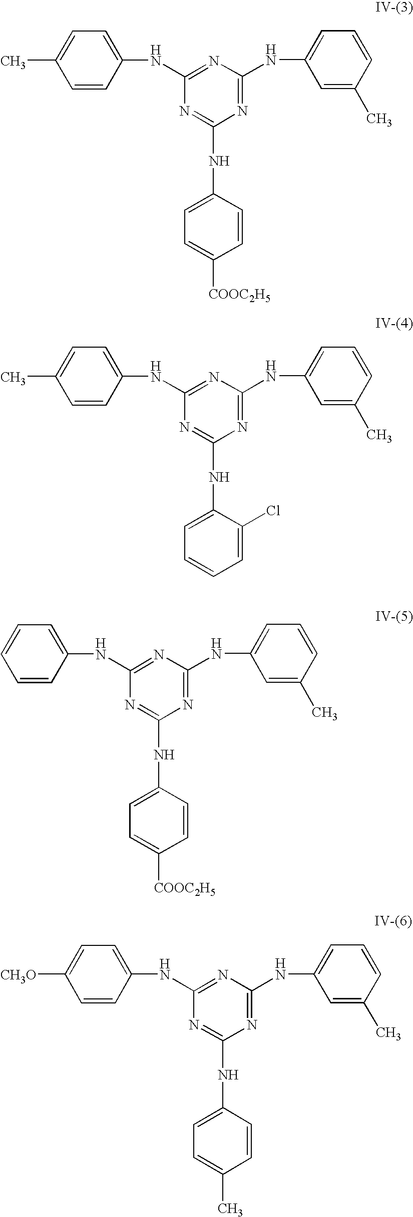

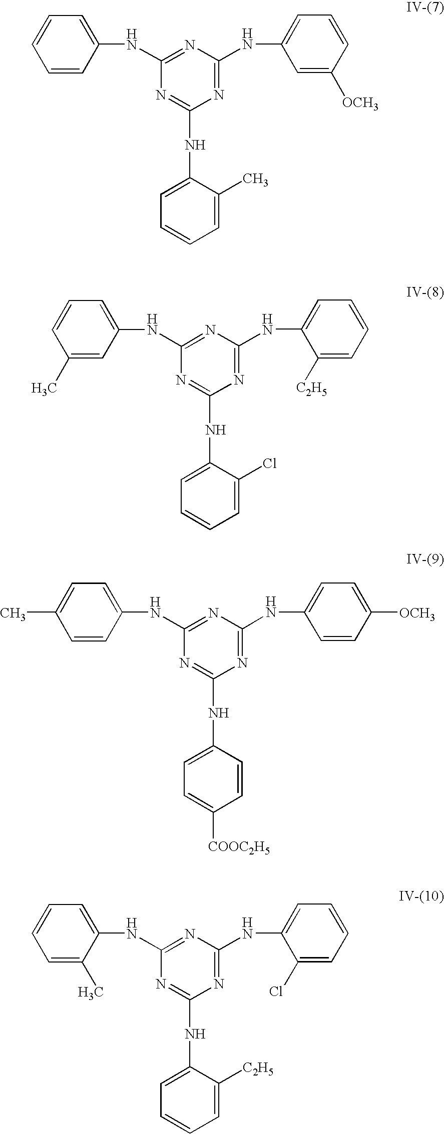

The amount of the material having reversed or regular wavelength dispersion characteristics to be added to the film is not limited and decided depending on its type, the type of polymer film to be used along with the material, or the application. Generally, the amount is preferably from 0.1 to 30% by mass, more preferably from 0.5 to 20% by mass and even more preferably from 1 to 10% by mass with respect to the total mass of the polymer composition.

At least one type of plasticizer may be added to the polymer film of the invention for improving the mechanical properties thereof and promoting the drying step. Plasticizer may preferably be phosphate ester and/or carboxylate ester. The phosphate ester-base plasticizer may preferably be exemplified by triphenyl phosphate (TPP) and tricresyl phosphate (TCP). Typical examples of carboxylate ester-base plasticizer are phthalate esters and citrate esters. Examples of the phthalate ester-base plasticizer include dimethyl phthalate (DMP), diethyl phthalate (DEP), dibutyl phthalate (DBP), dioctyl phthalate (DOP), diphenyl phthalate (DPP) and diethylhexyl phthalate (DEHP). Examples of the citrate ester-base plasticizer include O-acetyl triethyl citrate (OACTE) and tributyl O-acetyl citrate (OACTB). Examples of the other carboxylate ester-base plasticizer include butyl oleate, methyl acetyl ricinoleate, dibutyl sebacate and various trimellitic acid esters. Phthalate ester-base plasticizers such as DMP, DEP, DBP, DOP, DPP and DEHP are preferable; and DEP and DPP are especially preferable.

Examples of the plasticizer which can be used in the invention also include sugar derivatives, having acyl(s) in place of hydrogen atom(s) of all of or a part of OH groups, described in WO/2007/125764 pamphlet, [0042]-[0065].

The amount of the plasticizer(s) to be added to the film is preferably from 0.1 to 25% by mass, more preferably from 1 to 20% by mass and even more preferably from 3 to 15% by mass with respect to the mass of the polymer which is a main ingredient.

Other additives such as a deterioration inhibitor (e.g., an antioxidizing agent, peroxide decomposer, radical inhibitor, metal inactivating agent, oxygen scavenger, or amine) may be added to the polymer film of the invention. Deterioration inhibitors are described in JP-A Nos. hei 3-199201, hei 5-1907073, hei 5-194789, hei 5-271471, and hei 6-107854. The additive amount of the deterioration inhibitor is preferably 0.01 to 1 percent by mass, and more preferably 0.01 to 0.2 percent by mass of the solution (dope) to be prepared. When the additive amount is less than 0.01 percent by mass, the effect of the deterioration inhibitor is substantially unrecognizable. When the additive amount is in the excess of 1 percent by mass, the deterioration inhibitor may bleed out on the surface of the film. Butylated hydroxytoluene (BHT) and tribenzylamine (TBA) are particularly preferable deterioration inhibitors.

### 2. Polarizing Plate

The present invention relates to a polarizing plate having, at least, a polymer film of the invention and a linear polarizing film (in the description, referred to as “polarizing film”). The polymer film may be used as a protective film of a linear polarizing film. The polymer film of the invention has a difference in property between the two surfaces thereof. In the embodiments employing the polymer film whose wavelength dispersion of the refractivity anisotropy differs between two surfaces of the film, as shown in FIG. 1 (1), the polymer film may be bonded to a polarizing film so that the surface having larger reversed wavelength dispersion of refractivity anisotropy than that of another surface is faced to the surface of the polarizing film. In this way, it is possible to prepare a polarizing plate showing an optical compensation ability; and the ability is nearly equal to that of a polarizing plate prepared by bonding a polarizing film to a retardation film, having reversed wavelength dispersion characteristics of Re and regular wavelength dispersion characteristics of Rth.

The linear polarizing film is preferably a coated polarizing film typically by Optiva Inc., or a polarizing film comprising a binder, and iodine or a dichroic dye. Iodine and a dichroic die in the linear polarizing film express polarizability when aligned in binder. Iodine and the dichroic dye preferably align along the binder molecules, or the dichroic dye preferably aligns in one direction as self-textured like liquid crystal. Polarizing elements that are now commercially available are generally fabricated by dipping a stretched polymer in a solution of iodine or a dichroic dye in a dyeing bath, whereby iodine or the dichroic dye is infiltrated into the binder.

On the surface of the linear polarizing film opposite to the surface thereof to which the polymer film of the invention has been stuck, a polymer film is preferably disposed (in a configuration of the polymer film of the invention/polarizing film/polymer film).

Preferably, the polymer film has, as provided thereon, an antireflection film having soiling resistance and scratch resistance on its outermost surface. The antireflection film may be any conventional known one.

### 3. Liquid Crystal Display

The present invention relates also to a liquid crystal display having the polymer film of the invention. One example of the liquid crystal display of the invention is a liquid crystal display having at least one polarizing plate of the invention. The polymer film of the invention is expected to contribute to improving the displaying qualities of a liquid crystal display employing any mode due to its novel optical compensation ability. More specifically, the polymer film of the invention is expected to contribute to improving the displaying qualities of a liquid crystal display employing any mode such as TN (Twisted Nematic), IPS (In-Plane Switching), OCB (Optically Compensatory Bend), VA (Vertically Aligned) or ECB (Electrically Controlled Birefringence) mode due to its novel optical compensation ability. Especially, the polymer film of the invention is preferably used for optical compensation of a liquid crystal display employing a vertically aligned mode or a horizontally aligned mode.

### EXAMPLES

The invention is described more concretely with reference to the following Examples, in which the material and the reagent used, their amount and their ratio, the details of the treatment and the treatment process may be suitably modified or changed not overstepping the sprit and the scope of the invention. Accordingly, the scope of the invention should not be limited by the following Examples.

### 1. Examples of Production of Polymer Film:

The constitutive ingredients were mixed in the ratio shown in Table 1 below, thereby preparing cellulose acylate solutions (dopes). Using a band caster, the cellulose acylate solution was cast. In Table 1, “TD” means a transverse direction. Drying:

In these Examples, the dope, after having cast on the surface of the band, was dried on the band under any of the following two different drying conditions for the purpose of making the produced film have a difference in the refractivity anisotropy between the two surfaces of the film.

### (1) Drying Condition 1:

The film was dried at a drying air temperature of 25° C. (room temperature) and at a drying air speed of the course (around 0.2 m/sec). In this, a solvent vapor was kept remaining on the surface of the film so that the solvent concentration along the thickness direction of the film could be kept constant during drying.

### (2) Drying Condition 2

The film was dried with air applied to the film/air interface side, at a drying air temperature of 130° C. and at a speed of 10 m/sec.

### Stretching:

After dried, the web was peeled off from the band, then stretched under the condition shown in Table 1, and thereafter further dried to give cellulose acylate films 1 to 8 having the thickness shown in Table 1.

### Evaluation:

Thus produced, the cellulose acylate films were evaluated according to the above-mentioned methods for Δn(450), Δn(550) and Δn(650) of both surfaces of the film (surface A and surface B in the Table). In addition, Re and Rth of the entire film were measured and calculated according to the above-mentioned methods. The results are shown in the following Table.

In Table 1 and Table 3, the meanings of notations are as follows:
*1: the degree of substituent,
*2: the amount % by mass relative to the mass of cellulose acylate,
*3: the used material having reversed wavelength dispersion characteristics,
*4: the used material having regular wavelength dispersion characteristics.

TABLE 1

| | | Comparative | | Comparative | | Comparative | | Comparative |
|---|---|---|---|---|---|---|---|---|
| | Invention | Example | Invention | Example | Invention | Example | Invention | Example |
| Polymer Film No. | 1 | 2 | 3 | 4 | 5 | 6 | 7 | 8 |
| Polymer | Cellulose | Cellulose | Cellulose | Cellulose | Cellulose | Cellulose | Cellulose | Cellulose |
| | acylate | acylate | acylate | acylate | acylate | acylate | acylate | acylate |
| | (2.92*¹) | (2.92*¹) | (2.86*¹) | (2.86*¹) | (2.80*¹) | (2.80*¹) | (2.86*¹) | (2.86*¹) |
| Plasticizer (1) | Triphenyl | Triphenyl | Plasticizer No. | Plasticizer | Plasticizer No. | Plasticizer | Triphenyl | Triphenyl |
| [amount*²] | phosphate | phosphate | No. 1 | No. 1 | No. 2 | No. 2 | phosphate | phosphate |
| | [3%] | [3%] | [3.6%] | [3.6%] | [10%] | [10%] | [7%] | [7%] |
| Plasticizer (2) | Biphenyl | Biphenyl | — | — | — | — | Biphenyl | Biphenyl |
| [amount*²] | phosphate | phosphate | [—] | [—] | [—] | [—] | phosphate | phosphate |
| | [2%] | [2%] | | | | | [5%] | [5%] |
| Rev. Material*³ | Rev. | Rev. Material | Rev. Material | Rev. Material | — | — | Rev. Material | Rev. Material |
| [amount*²] | Material | No. 1 | No. 1 | No. 1 | [—] | [—] | No. 1 | No. 1 |
| | No. 1 [6%] | [6%] | [4%] | [4%] | | | [2%] | [2%] |
| Reg. Material*⁴ (1) | Reg. | Reg. Material | Reg. Material | Reg. Material | Reg. Material | Reg. | Reg. Material | Reg. Material |
| [amount*²] | Material | No. 2 [5%] | No. 1 | No. 1 | No. 2 | Material | No. 1 | No. 1 [2%] |
| | No. 2 [5%] | | [5%] | [5%] | [5%] | No. 2 [5%] | [2%] | |
| Reg. Material*⁴ (2) | — | — | Reg. Material | Reg. Material | — | — | Reg. Material | Reg. Material |
| [amount*²] | [—] | [—] | No. 2 | No. 2 | [—] | [—] | No. 2 | No. 2 [2%] |
| | | | [0.6%] | [0.6%] | | | [2%] | |
| Drying Condition | 1 | 2 | 1 | 2 | 1 | 2 | 1 | 2 |
| Stretching ratio | 23% | 23% | 27% | 27% | 25% | 25% | 30% | 30% |
| Stretching | 170° C. | 170° C. | 170° C. | 170° C. | 160° C. | 160° C. | 170° C. | 170° C. |
| temperature | | | | | | | | |
| Film thickness | 50 μm | 50 μm | 50 μm | 50 μm | 85 μm | 85 μm | 52 μm | 52 μm |

TABLE 2

| | | | Comparative | | Comparative | | Comparative | | Comparative |
|---|---|---|---|---|---|---|---|---|---|
| | | Invention | Example | Invention | Example | Invention | Example | Invention | Example |
| Film No. | | 1 | 2 | 3 | 4 | 5 | 6 | 7 | 8 |
| A*1 | Δ n(450) | 0.0011 | 0.0017 | 0.0014 | 0.0018 | 0.0004 | 0.0006 | 0.0008 | 0.0010 |
| | Δ n(550) | 0.0014 | 0.0020 | 0.0016 | 0.0020 | 0.0005 | 0.0007 | 0.0009 | 0.0011 |
| | Δ n(630) | 0.0016 | 0.0023 | 0.0017 | 0.0021 | 0.0005 | 0.0007 | 0.0009 | 0.0011 |
| B*2 | Δ n(450) | 0.0022 | 0.0017 | 0.0022 | 0.0018 | 0.0008 | 0.0006 | 0.0013 | 0.0010 |
| | Δ n(550) | 0.0026 | 0.0020 | 0.0024 | 0.0020 | 0.0008 | 0.0007 | 0.0013 | 0.0011 |
| | Δ n(630) | 0.0030 | 0.0023 | 0.0025 | 0.0021 | 0.0008 | 0.0007 | 0.0013 | 0.0011 |
| B-A*3 | Δ n(450) | 0.0011 | 0.0000 | 0.0008 | 0.0000 | 0.0004 | 0.0000 | 0.0005 | 0.0000 |
| | Δ n(550) | 0.0012 | 0.0000 | 0.0008 | 0.0000 | 0.0003 | 0.0000 | 0.0004 | 0.0000 |
| | Δ n(630) | 0.0014 | 0.0000 | 0.0008 | 0.0000 | 0.0003 | 0.0000 | 0.0004 | 0.0000 |
| Film*4 | Re(446)[nm] | 82 | 82 | 90 | 90 | 54 | 54 | 53 | 53 |
| | Re(548)[nm] | 101 | 101 | 102 | 102 | 58 | 58 | 57 | 57 |
| | Re(629)[nm] | 115 | 115 | 105 | 105 | 60 | 60 | 59 | 59 |
| | Rth(446)[nm] | 103 | 103 | 109 | 109 | 125 | 125 | 112 | 112 |
| | Rth(548)[nm] | 126 | 126 | 126 | 126 | 132 | 132 | 116 | 116 |
| | Rth(629)[nm] | 144 | 144 | 133 | 133 | 138 | 138 | 118 | 118 |

*1the properties of Surface A (the air-side surface)
*2the properties of Surface B (the support-side surface)
*3the difference in each property between Surface A and Surface B (Surface B − Surface A)
*4the properties of the film as a whole

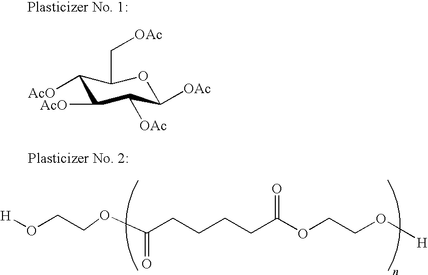

Material No. 1 having regular wavelength dispersion characteristics (Reg. Material No. 1):

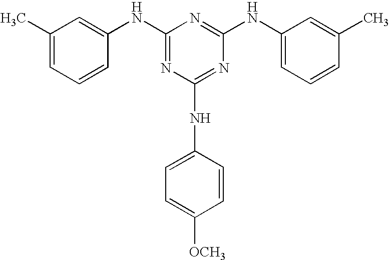

Material No. 2 having regular wavelength dispersion characteristics (Reg. Material No. 2):

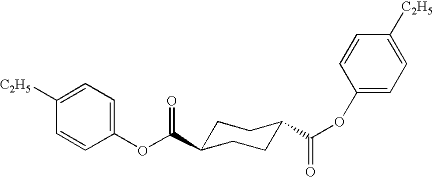

Material No. 1 having reversed wavelength dispersion characteristics (Rev. Material No. 1):

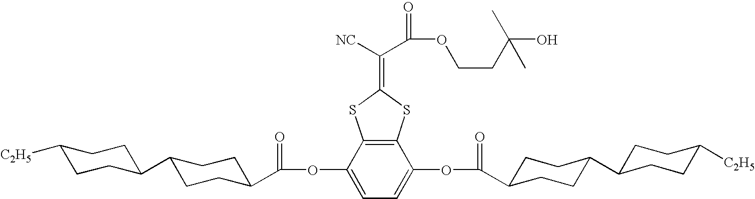

### 2. Examples of Production of Polymer Film:

Polymer films were produced in the same manner as in “1. Examples of Production of Polymer Film”, which, however, were not stretched. The films were dried under the “drying condition 1”. The optical properties of the thus-produced polymer films were determined and shown in the following Table.

TABLE 3

| | Film No. |
|---|---|
| | 9 |
| Polymer | Cellulose acylate |
| | (2.86*¹) |
| Plasticizer (1) | Triphenyl phosphate |
| [amount*²] | [7%] |
| Plasticizer (2) | Biphenyl phosphate |
| [amount*²] | [5%] |
| Rev. Material*³ | — |
| [amount*²] | — |
| Reg. Material*⁴ | Reg. Material No. 1 |
| [amount*²] | [7%] |
| Re(446)[nm] | −7 |
| Re(548)[nm] | −5.9 |
| Re(629)[nm] | −6.1 |
| Rth(446)[nm] | 111 |
| Rth(548)[nm] | 108 |
| Rth(629)[nm] | 106 |

### 3. Production of Polarizing Plate:

The surface of the polymer film produced in the above was saponified with alkali. Concretely, the film was dipped in an aqueous 1.5 N sodium hydroxide solution at 55° C. for 2 minutes, then washed in a water-washing bath at room temperature, and neutralized with 0.1 N sulfuric acid at 30° C. Again this was washed in a water-washing bath at room temperature, and dried with hot air at 100° C. Next, a roll of polyvinyl alcohol film having a thickness of 80 μm was unrolled and continuously stretched by 5 times in an aqueous iodine solution and dried to give a polarizing film having a thickness of 20 μm. The polarizing film was sandwiched between any of the above-mentioned, alkali-saponified polymer films 1 to 9 and a film of Fujitac TD80UL (by FUJIFILM) that had been alkali-saponified in the same manner as above, in such a manner that the saponified surfaces of those films could face the polarizing film, and these were stuck together with an aqueous 3% polyvinyl alcohol (Kuraray's PVA-117H) serving as an adhesive, thereby constructing a polarizing plate in which the polymer film and the film TD80UL are the protective films for the polarizing film.

Each of Polymer film Nos. 1 to 8 was so stuck to the polarizing film that its slow axis was perpendicular to the absorption axis of the polarizing film; and Polymer film No. 9 was so stuck thereto that its slow axis was parallel to the absorption axis of the polarizing film.

### 4. Production of Liquid-Crystal Display Devices Nos. 1 to 8:

Using the polarizing plates produced in the above, VA-mode liquid-crystal display deices Nos. 1 to 8 were constructed. Concretely, a VA-mode liquid-crystal cell (Δnd=300 nm) was used, and the polarizing plates were stuck to it on both the display panel side and the backlight side as in the combination shown in the following Table, thereby constructing the intended liquid-crystal display devices.

### (Evaluation of Liquid-Crystal Display Devices Nos. 1 to 8)

Using a tester (EZ-Contrast XL88, by ELDIM), VA-mode liquid-crystal display devices No. 1 to No. 8 constructed in the above were tested in a dark room for the brightness and the chromaticity in the black state and in the white state; and the color shift and the contrast ratio in the black state were determined through calculations.

### (Evaluation)

Transmittances in the black and white states:

Liquid-crystal display devices Nos. 1 to 8 constructed in the above were tested for the transmittance in the front direction (in the normal direction to the panel surface) and in the oblique direction (in the direction at a polar axis of 45 degrees and at an azimuth angle of 60 degrees) in the black state, thereby calculating the contrast in the front direction and the contrast in the oblique direction. The results are shown in the following Table.
Color shift in the black state:

Liquid-crystal display devices Nos. 1 to 8 constructed in the above were tested for the color shift, Δu′v′(=√(u′max−u′min)²+(v′max−v′min)²) at the time of black level of display. In this, u′max (v′max) means the maximum u′ (v′) in a range of from 0 to 360 degrees; and u′min (v′min) means the minimum u′ (v′) in a range of from 0 to 360 degrees. The results are shown in the following Table.

TABLE 4

| | | Comparative | | Comparative | | Comparative | | Comparative |
|---|---|---|---|---|---|---|---|---|
| | Invention | Example | Invention | Example | Invention | Example | Invention | Example |
| LCD No. | 1 | 2 | 3 | 4 | 5 | 6 | 7 | 8 |
| Displaying | 1 | 2 | 3 | 4 | 5 | 6 | 7 | 8 |
| side | | | | | | | | |
| Polymer | | | | | | | | |
| Film No. | | | | | | | | |
| LC cell | VA | VA | VA | VA | VA | VA | VA | VA |
| Backlight | 9 | 9 | 9 | 9 | 5 | 6 | 7 | 8 |
| side | | | | | | | | |
| Polymer | | | | | | | | |
| film No. | | | | | | | | |
| Contrast | 92 | 82 | 89 | 80 | 85 | 78 | 84 | 76 |
| ratio *1 | | | | | | | | |
| Δu′v′ | 0.01 | 0.042 | 0.014 | 0.048 | 0.022 | 0.054 | 0.024 | 0.056 |

*1: Contrast ratio in the direction of a polar angle of 45 degrees and an azimuth angle of 60 degrees.

What is claimed is:

1. A polymer film stretched after prepared according to solvent casting method, of which the wavelength dispersion of the refractivity anisotropy and/or the refractivity anisotropy differs between two surfaces of the film.

2. The polymer film of claim 1, having a gradation in the wavelength dispersion characteristics of the refractivity anisotropy and/or in the refractivity anisotropy along the thickness direction of the film.

3. The polymer film of claim 1, of which the in-plane retardation (Re) is larger at a longer wavelength within a wavelength range of from 430 nm to 700 nm.

4. The polymer film of claim 1, of which the refractivity anisotropy in one of the two surfaces of the film is larger than the refractivity anisotropy at the center point in the thickness direction of the film.

5. The polymer film of claim 1, comprising at least one material having reversed wavelength dispersion characteristics.

6. The polymer film of claim 1, comprising at least one material having reversed wavelength dispersion characteristics and at least one material having regular wavelength dispersion characteristics.

7. The polymer film of claim 1, comprising at least one cellulose acylate as the main ingredient thereof.

8. The polymer film of claim 1, comprising a cellulose acylate having at least two different types of substituents.

9. A polarizing plate comprising a polarizing film and a polymer film of claim 1 disposed on at least one surface of the polarizing film.

10. The polarizing film of claim 9, wherein the polymer film is a polymer film of which the wavelength dispersion of the refractivity anisotropy differs between two surfaces of the film, and wherein the surface of the film having a larger level of reversed wavelength dispersion characteristics is disposed to face the side of the polarizing film.

11. A liquid-crystal display comprising at least one polarizing plate of claim 9.

12. The liquid-crystal display of claim 11, employing a vertically aligned mode.

13. The liquid-crystal display of claim 11, employing a horizontally aligned mode.
